(19) United States
(12) Patent Application Publication
(10) Pub. No.: US 2007/0276675 A1
(43) Pub. Date: Nov. 29, 2007

(54) Innovation management system, apparatus, and method

(76) Inventors: John J. Gabrick, Pittsburgh, PA (US); Cassius A. Elston, Sammamish, WA (US); Charles Monfradi, Wheeling, WV (US); Michael R. Sarnowski, Bridgeville, PA (US)

Correspondence Address: THE LAW OFFICE OF RICHARD W. JAMES, 25 CHURCHILL ROAD, CHURCHILL, PA, 15235, US

(21) Appl. No.: 11/242,616

(22) Filed: Oct. 3, 2005

Related U.S. Application Data
(63) Continuation-in-part of application No. 10/985,731, filed on Nov. 10, 2004.
Application No. 10/985,731 is a continuation-in-part of application No. 10/459,116, filed on Jun. 10, 2003.
Application No. 10/459,116 is a continuation-in-part of application No. 09/709,900, filed on Nov. 10, 2000.
(60) Provisional application No. 60/615,400, filed on Oct. 1, 2004.

(51) Int. Cl. G06F 17/00

(52) U.S. Cl. 705/1

(57) ABSTRACT

Methods, apparatuses, and systems for an innovation management system.

### FIELD OF THE INVENTION

The invention described herein relates to aspects of computer assisted systems, apparatuses, and methods for managing innovations

### BACKGROUND OF THE INVENTION

Innovations and intellectual property are important for the improvement of business efficiency and products and the advancement of society. The value of innovations is not, however, always appreciated, protected, or utilized. Thus there is a need for computer assisted systems, apparatuses, and methods for managing innovations, recognizing valuable innovations, bringing those innovations to fruition, utilizing those innovations, preserving proprietary rights in those innovations and creating value from those innovations.

### SUMMARY OF THE INVENTION

Inventions described herein include systems, apparatuses and methods that associate information with innovations provided to the system. Embodiments store those innovations and associated information in a storage device. Embodiments also receive descriptions of innovations provided by users and/or provide those innovation descriptions to other users.

The results of using the innovation management systems, apparatuses, and methods may include the organization of innovations and innovation related information, tracking when innovations are conceived, valuing innovations, securing innovations and related information, sharing innovations and related information within a secure system, and promotion of multi-person innovation.

Accordingly, the inventions described herein provide solutions to the shortcomings of innovation development. Those of ordinary skill in the art will readily appreciate, therefore, that those and other details, features, and advantages of the inventions described herein will become further apparent in the following detailed description of the preferred embodiments of the invention.

### BRIEF DESCRIPTION OF THE DRAWINGS

The detailed description is better understood in conjunction with the accompanying drawings, in which like reference characters represent like elements, as follows:

FIG. 1 illustrates an embodiment of an innovation management system;

FIG. 2 illustrates an embodiment of an innovation management network;

FIG. 3 illustrates an embodiment of an innovation management home page display;

FIG. 4 illustrates an embodiment of a navigation menu;

FIG. 5 illustrates an embodiment of a function selection menu;

FIG. 6 illustrates an embodiment of a navigation display;

FIG. 7 illustrates an embodiment of a return to previous display navigation display;

FIG. 8 illustrates an embodiment of a submitted innovation spotlight display;

FIG. 9 illustrates an embodiment of an innovation highlight display;

FIG. 10 illustrates an embodiment of a status display;

FIG. 11 illustrates an embodiment of an innovation challenge display;

FIG. 12 illustrates an embodiment of a user information display;

FIG. 13 illustrates an embodiment of a search link;

FIG. 14 illustrates an embodiment of a search display;

FIG. 15 illustrates an embodiment of an expert search display;

FIG. 16 illustrates an embodiment of an innovation information display;

FIG. 17 illustrates an embodiment of an innovation selection and option menu;

FIG. 18 illustrates an embodiment of a file selection display;

FIG. 19 illustrates an embodiment of an other attachments display;

FIG. 20 illustrates an embodiment of a user innovation display;

FIG. 21 illustrates an innovation submission overview display;

FIG. 22 illustrates an embodiment of a shared innovations display;

FIG. 23 illustrates an embodiment of an innovation information display;

FIG. 24 illustrates an embodiment of an analysis results display;

FIG. 25 illustrates an embodiment of an activity log display;

FIG. 26 illustrates an embodiment of a search agent configuration display;

FIG. 27 illustrates an embodiment of a search results display;

FIG. 28 illustrates an embodiment of a review committee display;

FIG. 29 illustrates an embodiment of a request display;

FIG. 30 illustrates an embodiment of a review committee status display;

FIG. 31 illustrates an embodiment of a timeline display;

FIG. 32 illustrates an embodiment of an innovation snapshot display;

FIG. 33 illustrates an embodiment of a reward display;

FIG. 34 illustrates an embodiment of educational information display;

FIG. 35 illustrates an embodiment of a collaboration agents display;

FIG. 36 illustrates an embodiment of a collaboration agents search display;

FIG. 37 illustrates an embodiment of a discussion display;

FIG. 38 illustrates an embodiment of a comments display;

FIG. 39 illustrates an embodiment of an innovation showcase display;

FIG. 40 illustrates an embodiment of a current challenges display;

FIG. 41 illustrates an embodiment of a challenge details display;

FIG. 42 illustrates an embodiment of a user profile display;

FIG. 43 illustrates an embodiment of a login display;

FIG. 44 illustrates an embodiment of a contact information display;

FIG. 45 illustrates an embodiment of a user login creation display;

FIG. 46 illustrates an embodiment of a user profile creation and modification display;

FIG. 47 illustrates an embodiment of a user name lookup display;

FIG. 48 illustrates an embodiment of an additional inventors display;

FIG. 49 illustrates an embodiment of a new task display; and

FIG. 50 illustrates an embodiment of a tasks to do display.

### DETAILED DESCRIPTION

Reference will now be made to embodiments of an innovation management system and method, examples of which are illustrated in the accompanying drawings. Details, features, and advantages of the management system and method will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification do not necessarily all refer to the same embodiment. References to “or” are furthermore intended as inclusive, so “or” may indicate one or another of the ored terms or more than one ored term.

One or more embodiments of an innovation management system described herein may describe matter related to The MindMatters Technologies'Innovator™ Innovation Management System, which may facilitate inspiration, management, and protection of intellectual property and/or other information throughout the invention process.

One or more embodiments of an innovation management system described herein may facilitate the inspiration of new ideas, inventions, intellectual capital and creative thinking amongst employees and/or other users from R&D and some or all other aspects of an organization, and may provide a company-updated forum in which future needs (inspirations for new ideas) are communicated to those users to stimulate creativity.

One or more embodiments of an innovation management system described herein may manage innovation information and other intellectual assets in a database by facilitating collaboration, providing analysis modules, time and date stamping, and/or an organization-driven measurement system that immediately notes or “flags” the ideas of interest, and rejects ideas not of interest and returns them to the submitter. One or more embodiments described herein may manage intellectual assets in a database, including some or all steps from inspiration to commercialization.

One or more embodiments of an innovation management system described herein may protect the intellectual assets of an organization from inadvertent disclosure by tracking employee or other user input regarding innovations, and through encryption and/or the designation of security privileges to users. On or more embodiments described herein may protect and stimulate the growth of intellectual assets by providing a database of associated educational information, such as information that facilitates United States Patent and Trademark Office (USPTO) and/or other prior art searches.

One or more embodiments of an innovation management system described herein may include, and the methods may employ, a computer program, such as a software program, that may be employed in a computerized system, wherein information may be organized in a database and may be displayed by the management system so as to be accessible and viewable by way of a computer software or other application with a user interface, such as a graphical user interface. The computer program may operate over a network and/or the Internet.

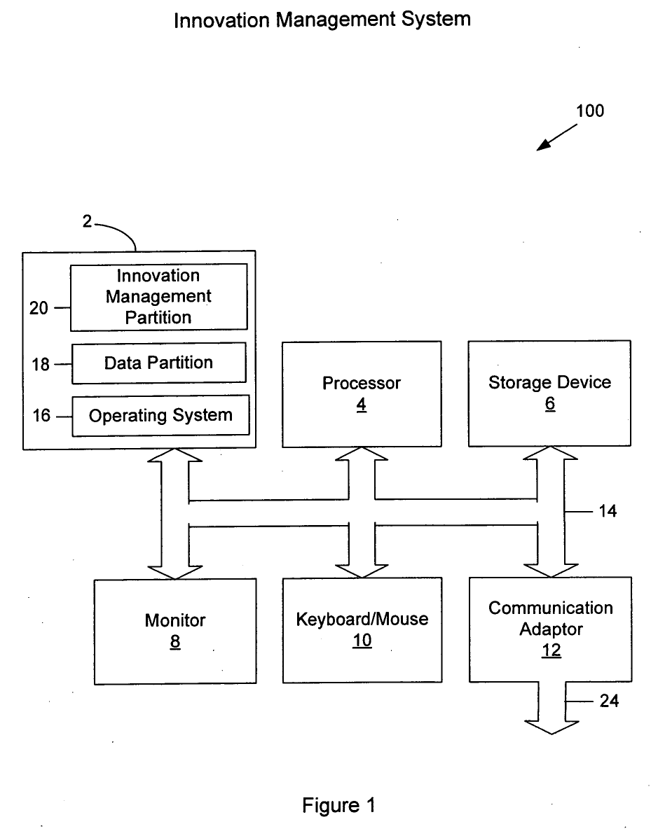

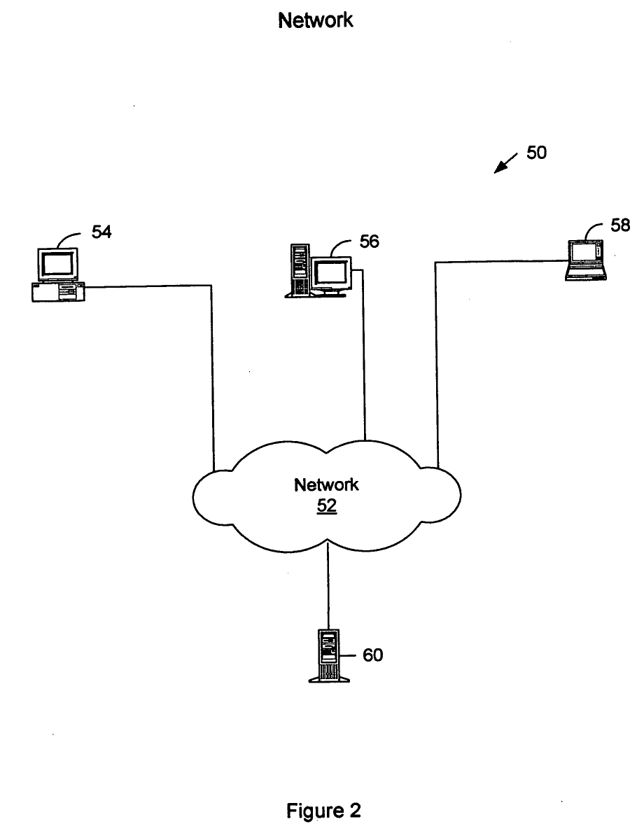

One or more embodiments of an innovation management system described herein may include, and the methods may employ, a computer system such as described with respect to FIGS. 1 and 2.

FIG. 1 illustrates an embodiment of an innovation management system 100 that may be used to perform one or more of the functions described herein with respect to an innovation management system. The innovation management system 100 in this embodiment includes memory 2, a processor 4, a storage device 6, a monitor 8, a keyboard and/or mouse 10, and a communication adaptor 12. Communication between the processor 4, the storage device 6, the monitor 8, the keyboard or mouse 10, and the communication adaptor 12 is accomplished by way of a communication bus 14.

It should be recognized that any or all of the components 2-12 of the innovation management system 100 may be implemented in a single machine. For example, the memory 2 and processor 4 might be combined in a state machine or other hardware based logic machine.

The memory 2 may, for example, include random access memory (RAM), dynamic RAM, and/or read only memory (ROM) (e.g., programmable ROM, erasable programmable ROM, or electronically erasable programmable ROM) and may store computer program instructions and information. The memory may furthermore be partitioned into sections including an operating system partition 16 in which operating system instructions are stored, a data partition 18 in which data is stored, and an innovation management partition 20 in which instructions for carrying out innovation management functions are stored. The innovation management partition 20 may store program instructions and allow execution by the processor 4 of the program instructions. The data partition 18 may furthermore store data such as text, drawings, attachments, and other information during the execution of the program instructions.

The processor 4 may execute the program instructions and process the data stored in the memory 2. In one embodiment, the instructions are stored in memory 2 in a compressed and/or encrypted format. As used herein, the phrase “executed by a processor” is intended to encompass instructions stored in a compressed and/or encrypted format, as well as instructions that may be compiled or installed by an installer before being executed by the processor 4.

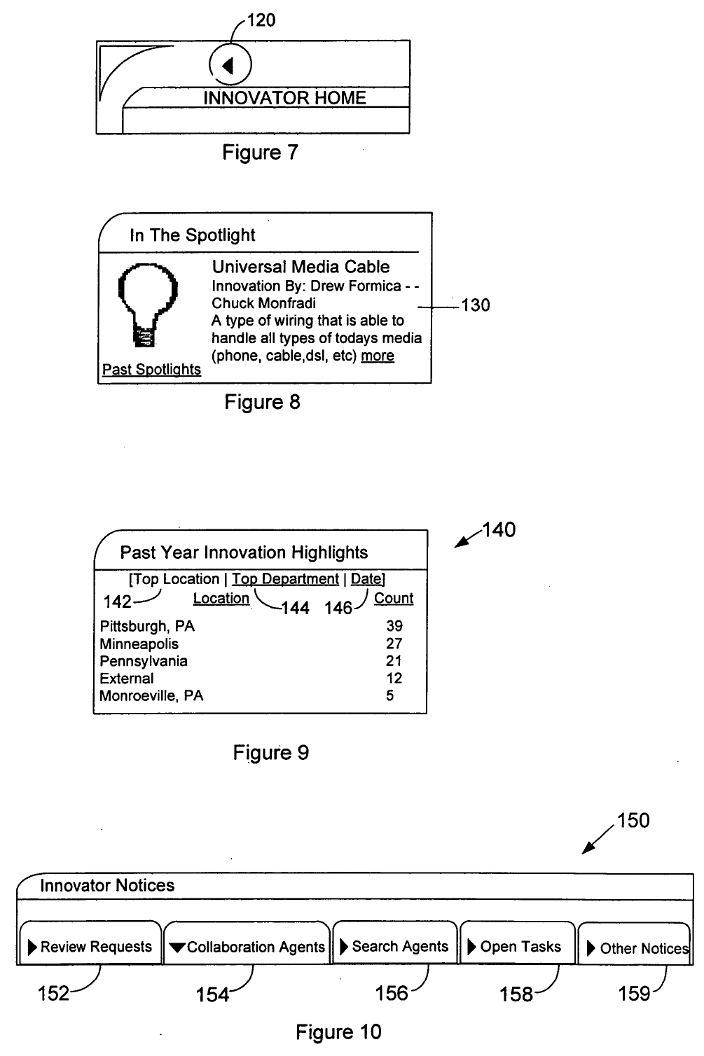

The storage device 6 may, for example, be a magnetic disk (e.g., floppy disk and hard drive), optical disk (e.g., CD-ROM) or any other device or signal that can store digital information. The communication adaptor 12 permits communication between the innovation management system 100 and other devices or nodes coupled to the communication adaptor 12 at the communication adaptor port 24. The communication adaptor 12 may be a network interface that transfers information from nodes on a network to the imaging interface 1 or from the innovation management system 100 to nodes on the network. The network may be a local or wide area network, such as, for example, the Internet, the World Wide Web, or the network 50 illustrated in FIG. 7. It should be recognized that the innovation management system 100 may alternately or in addition be coupled directly to one or more other devices through one or more input/output adaptors (not shown).

The innovation management system 100 may also be generally coupled to output devices 8 such as, for example, a monitor 8 or printer (not shown), and various input devices such as, for example, a keyboard or mouse 10. Moreover, other components of the innovation management system 100 may not be necessary for operation of the innovation management system 100. For example, the storage device 6 may not be necessary for operation of the innovation management system 100 as all information referred to by the innovation management system 100 may, for example, be held in memory 2.

The elements 2, 4, 6, 8, 10, and 12 of the innovation management system 100 may communicate by way of one or more communication busses 14. Those busses 14 may include, for example, a system bus, a peripheral component interface bus, and an industry standard architecture bus.

A network in which the innovation management system 1 may be implemented may be a network of nodes such as computers, telephones, or other, typically processor-based, devices interconnected by one or more forms of communication media. The communication media coupling those devices may include, for example, twisted pair, co-axial cable, optical fibers, and wireless communication methods such as use of radio frequencies. A node operating in connection with or as an innovation management system 100 may receive the data stream 52 from another node coupled to a Public Switched Telephone Network (PSTN), the Internet, a Local Area Network (LAN), a Wide Area Network (WAN), or another network.

Network nodes may be equipped with the appropriate hardware, software, or firmware necessary to communicate information in accordance with one or more protocols, wherein a protocol may comprise a set of instructions by which the information is communicated over the communications medium. For example, the OSI architecture, which includes a physical layer, a data link layer, a network layer, a transport layer, a session layer, a presentation layer, and an application layer, or a subset thereof may be used for network communication.

FIG. 2 illustrates an embodiment of a network 50 in which the innovation management system 100 may operate. The network may include two or more nodes 54, 56, 58, 60 coupled to a network 52 such as a LAN, a WAN, the Internet, or a telephone network such as a PSTN.

The network 50 may include an innovation management node 54 receiving a data stream such as innovation information from a second node such as the nodes 56, 58, and 60 coupled to the network 52.

In an embodiment, an innovation management system 100 includes a processor that executes instructions and thereby causes the processor to perform functions described herein.

In another embodiment, an article of manufacture includes a computer readable medium that includes instructions which, when executed by a processor, cause the processor to perform functions described herein with respect to an innovation management system.

In one embodiment, the innovation management system employs a computer program in a computerized system. A user may access the management system by executing the program through a computer or other system or device and viewing presentations of the executed program through a user interface.

In one embodiment, the innovation management system presents, to a user, a section that may be called the “Getting Started” section and outlines how a user may begin to employ the innovation management system. This section may outline steps a user may take in employing the innovation management system, including logging on, submitting an innovation submission, performing an analysis on an innovation submission, and updating biographical information.

An “innovation submission” includes information associated with an innovation of one or more users that the one or more users or others enter into an innovation management system for processing. Information associated with an innovation may include, for example, any combination of the following information: a title of the innovation; a description of the innovation; innovation keywords; dates and/or times relevant to the innovation, such as dates of invention, conception and operability of the innovation, public disclosure dates, and/or dates of filings made for securing intellectual property rights; inventor information; information supporting the innovation, such as invention disclosures and papers or other information documenting research and experimentation on the innovation; information that may be relevant to the scope of intellectual property rights the innovation may secure, such as patents, trademarks, and other intellectual property publications; information identifying locations of matter relevant to the innovation, such as prototypes and labs where experiments have been or are being conducted or places where information concerning the innovation is stored; and other information relevant to the innovation. The information associated with the innovation may be submitted at once or at different times. The information associated with the innovation may be typed or otherwise directly input into an innovation management system, or may be submitted as attachments. The information associated with the innovation may be in one or more formats, including, for example, text, drawings and other images, voice and other sound recordings, video recordings, and other formats.

Menu System

In one embodiment, the innovation management system provides a menu system that may be displayed as and operate as a hierarchical interface, such as a tree-like hierarchical shell interface, that lists or shows functions and/or databases a user may employ. The menu system may be dynamically created for each user based on his or her access rights, preferences, and associated information, such as user profile information as described herein. For example, each time a user submits an innovation submission, the menu may be updated with the innovation. A user may employ the menu system and the management system by selecting an option that may be related to a function and/or database, and the innovation management system will automatically execute the option, such as by performing a function or providing access to a database. A user may select the option, for example, by “clicking” a mouse on the text, symbol, link or other display associated with the desired option.

As used herein, the term “click” refers to a function of a keyboard, mouse, pointer or other input device that actuates or otherwise employs a displayed hyperlink, hypertext, or other link, which prompts the innovation management system to display or otherwise output information associated with the link. The “click” may be a single or double mouse-click. A link may be referred to herein as a “tab,” “button,” “option,” “heading,” “link,” or other name for matter that is displayed or otherwise outputted by the innovation management system, and which may be clicked. The menu system may include functionality described with respect to any or all embodiments of the innovation management system described herein.

Home Page

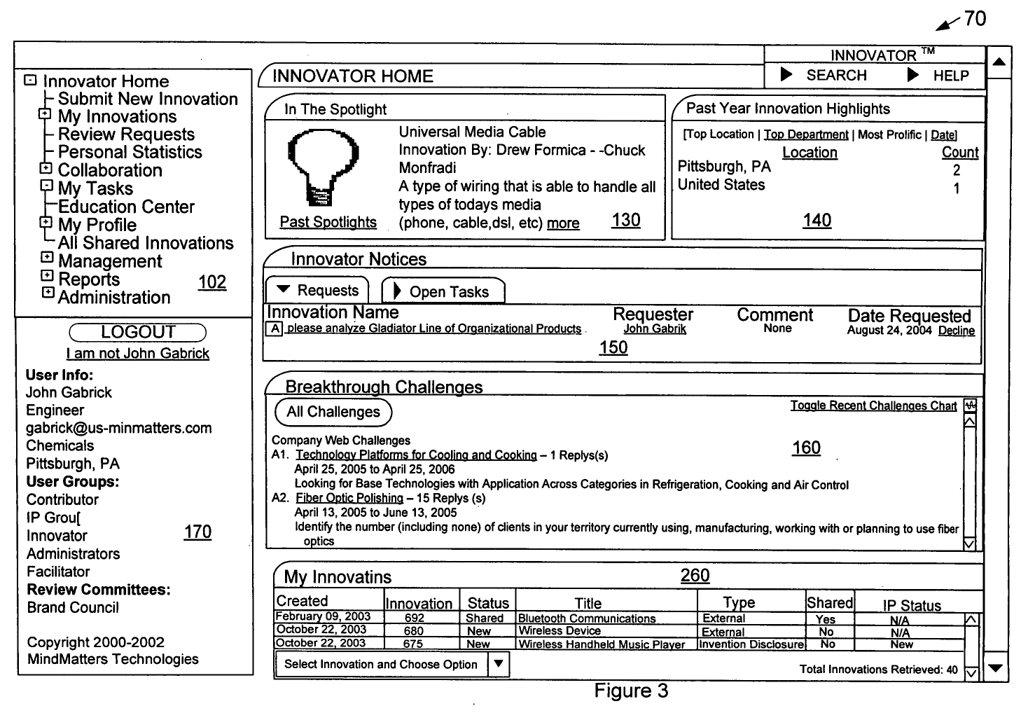

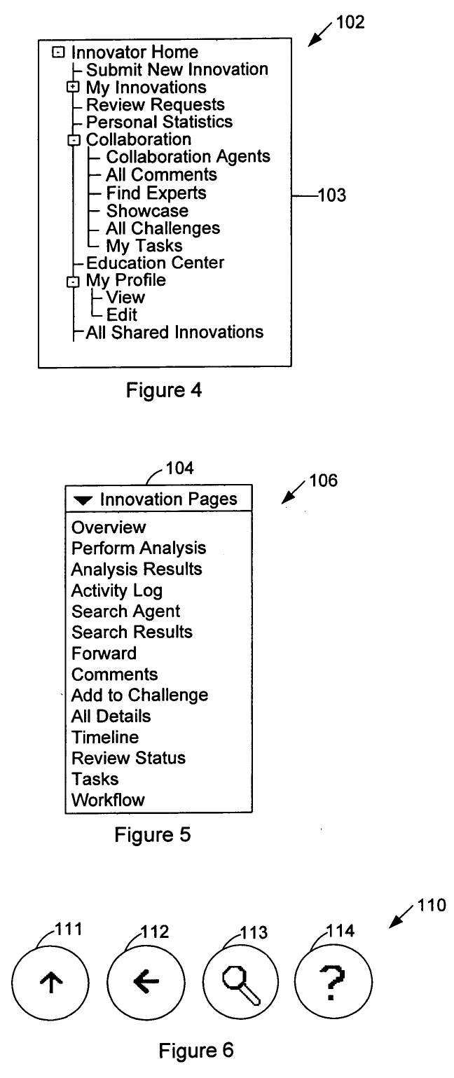

FIG. 3 illustrates an innovation management home page 70 of an embodiment of an innovation management node 54, 56, 58, 60 that may be the innovation management system 100 illustrated in FIG. 1 and may operate on a network such as the network 150 illustrated in FIG. 2. The home page 70 in that embodiment is a display that includes, as described herein with respect to FIGS. 4, 8 through 12, and 14, respectively, a navigation menu 102, a spotlight area 130, an innovation highlights area 140, a status window 150, a breakthrough challenges display 160, a user information display 170, a search graphic 180, a My Innovations display 260. The home page 70 may additionally include other displays described herein, or may include some combination of the other displays and the displays shown in the FIG. 3 embodiment. In one embodiment, each user of the innovation management system has a unique home page 70 that includes information associated with that user.

In an embodiment, each user may customize his or her home page 70 to include one or more of the displays described herein with respect to an innovation management system. For example, from the navigation menu 102, the user may click the “My Profile” option, then the “Edit” button to receive a display (not shown) that includes a “Preferences” button. The user may click the “Preferences” button to view a list of home page displays (not shown) from which the user may select the desired display, then click a “Save” button (not shown) to save the display. The desired display may be a combination of displays described herein. Clicking the “Preferences” button may also provide a list of display colors (not shown) that may each be clicked by the user to designate a color scheme in which the home page and/or other displays will be presented to the user. Clicking the “Save” button will save the color scheme.

In another embodiment, the display and functionality described with respect to FIGS. 4, 8 through 12, and 14 may be included on one or more pages of the innovation management system instead of or in addition to the home page 70.

FIG. 4 illustrates an embodiment of a navigation menu 102 that may be incorporated into the home page 70 or elsewhere in an innovation management system as desired. In that embodiment of the navigation menu 102 text options that are preceded by a “+” may be clicked to expand the menu to receive additional text options. Such a menu system may facilitate navigation of the innovation management system 100 to locate an innovation or perform a function. The innovation management home page 70 may include a subset of the clickable options shown in the navigation menu 102 and may include additional options. The navigation menu 102 may be displayed on one or more pages throughout a networked innovation management system, including, for example, on the home page of each user. The navigation menu 102 and other menus and displays described herein may furthermore be dynamically created based on the access rights and preferences of a user and may also be dynamically created to display only data created by, applicable to, or desired by a user. Thus, for example, when a user submits a new innovation submission to the innovation management system, the navigation menu may expand to include an option to access that newly submitted innovation submission. In an embodiment, a user may click that option to receive a display associated with the innovation submission, such as the Innovation Submission Overview page 900 of FIG. 21.

FIG. 5 illustrates a function selection menu 106 that may be included in the innovation management home page 70 or elsewhere to access pages concerning innovation submissions. The function selection menu 106 may include links a user may click to facilitate navigation of the innovation management system. For example, the function selection menu 106 may be accessible by way of a clickable tab 104 at the top of any page that highlights an innovation submission. The tab 104 may present one or more of the clickable options shown in FIG. 5 and those options may be a subset of the options available through the navigation menu 102 illustrated in FIG. 4.

As used herein, the term “page” refers to a display of information that is viewable via an output device or system such as the innovation management system illustrated in FIG. 1, one of the nodes 54, 56, 58, 60 illustrated in FIG. 2, any general purpose computing device from a Personal Digital Assistant (PDA) to a mainframe computer, a user interface or other device or system, whether described herein. Portions of the displayed information may be configured to be clicked, to be selected, to receive input such as typed information, or to be otherwise employed. A page may be, for example, a webpage, window, or other presentation that may be viewable through a graphical user interface or other output device, and for which information may be input by a user through a mouse, keyboard, or other input device. A page may include hyperlinks, hypertext, and/or other links or displays that, when clicked, may provide additional information and/or pages or may prompt the innovation management system to execute a function.

As shown in the embodiment of FIG. 6, one or more pages of the innovation management system may also include one or more navigation “buttons” 110, for example, at the bottom of the pages. In one embodiment, when selected or clicked, button 111 sends a user to the top of the current page, button 112 sends a user to the previous page, button 114 sends a user to the search page, and button 115 accesses a help function.

In the embodiment of the innovation management system shown in FIG. 7, which may be unlike a conventional web application, instead of clicking a browser's back and forward buttons to navigate, a user may click a system back button 120 in the upper left-hand corner to return to a previously accessed page.

Spotlight

In the embodiment shown in FIG. 8, the innovation management system home page 70 includes an area 130, which may be referred to as the “spotlight area,” that displays listings of innovation submissions that may be of particular interest to some or everyone using the innovation management system. The spotlight area 130 may be included on one or more of the pages of the innovation management system and is included in the innovation management home page 70 illustrated in FIG. 3. The spotlighted innovation submissions may have passed through some pre-defined levels of qualification, such as by having been reviewed and achieving a high analysis score, as described hereinafter. An administrator or other user may determine which innovations will be spotlighted and employ the innovation management system to input or access these innovation submissions and display listings of them in area 130. Alternately, the innovation management system may include rules for selecting innovation submissions listings to be displayed in the spotlight area 130.

Innovation Highlights

In the embodiment shown in FIG. 9, the innovation management system includes an innovation highlights area 140 that displays the leading innovation submission results that may be categorized, for example, by Top Department, Top Location, Most Prolific User and Date or Dates of innovation submissions. Top Department and Top Location may include lists of the number of innovation submissions provided by either a department or location in an organization. Most Prolific may represent the users who have submitted the most innovation submissions. Date may represent the people who have most recently submitted innovation submissions. The links Top Location 142, Top Department 144, “Most Prolific” (not shown), or Date 146 may be selected or clicked to view the corresponding information.

Innovation Notices

In the embodiment shown in FIG. 10, the innovation management system includes a status window 150. The status window 150 may, for example, be displayed in one or more of the following situations: new search results have been found, such as described herein with respect to the Search Agent section; collaboration agents have returned new results, such as described herein with respect to the Collaboration Agents Overview; a user has open tasks, such as described herein with respect to the My Tasks section; a request has been made to a user to perform an analysis on an innovation, such as described herein with respect to the Perform Analysis section; new comments have been added to one of a user's innovations, such as described herein with respect to the Discussion/Comments Overview; and other notices have been sent to you.

The status window 150 may include headings that may be clicked to view details of a situation or function. The headings may include “Review Requests” 152, “Collaboration Agents” 154, “Search Agents” 156, “Open Tasks” 158, “Other Notices” 159, and/or other headings related to the situations and functions that are described herein.

Breakthrough Challenges

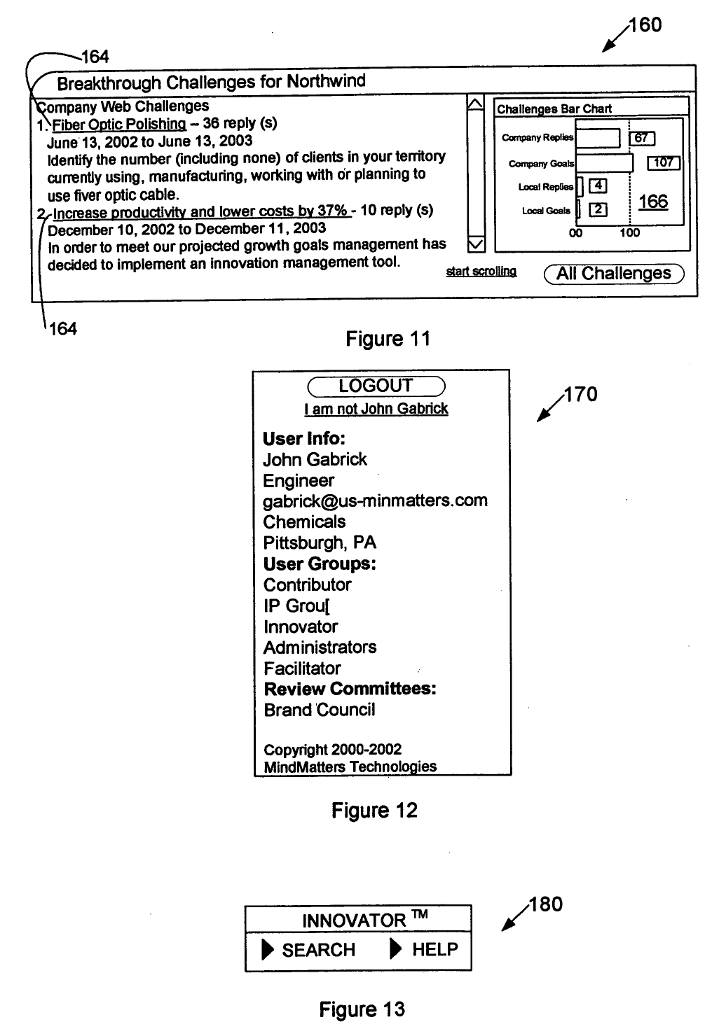

In the embodiment shown in FIG. 11, the innovation management system includes a breakthrough challenge display 160, listing challenges, which may be focused areas of innovation an organization of users is currently addressing. The breakthrough challenges display 160 includes a breakthrough chart 162 that shows the current results-to-date performance data relative to the challenges. The performance data in these areas may demonstrate progress toward the goals of these challenges. The innovation management system 100 may automatically receive challenges in various categories including, for example, global challenges that have been sent all users in an organization, and department-specific challenges that are sent only to the department or departments of one or more users. Challenges may be entered into the innovation management system 100 and may include matter such as that described herein in the Challenges section.

User Information

In the embodiment shown in FIG. 12, the innovation management system 100 includes a user information display 170, which may be displayed, for example, in the lower left corner of one or more of the management system 100 displays described herein. The user information display 170 may include, for example, the user's name, title, department, location, and/or which User Groups to which users have membership. This information may be updated as described herein in the My Profile section.

“User Groups” may be, in one embodiment, groups of users belonging to a category, such as, for example, a group of users that have the same security access privileges to information on the innovation management system, a group of users that belong to the same department of an organization, or a group of users that have similar expertise. The categories may be created by an innovation management system administrator or another user. “Security Access Privileges” may be privileges, assigned to each user, that designate the scope of information on the innovation management system each user may access. Security Access Privileges may be set by an innovation management system manager or another user.

Search

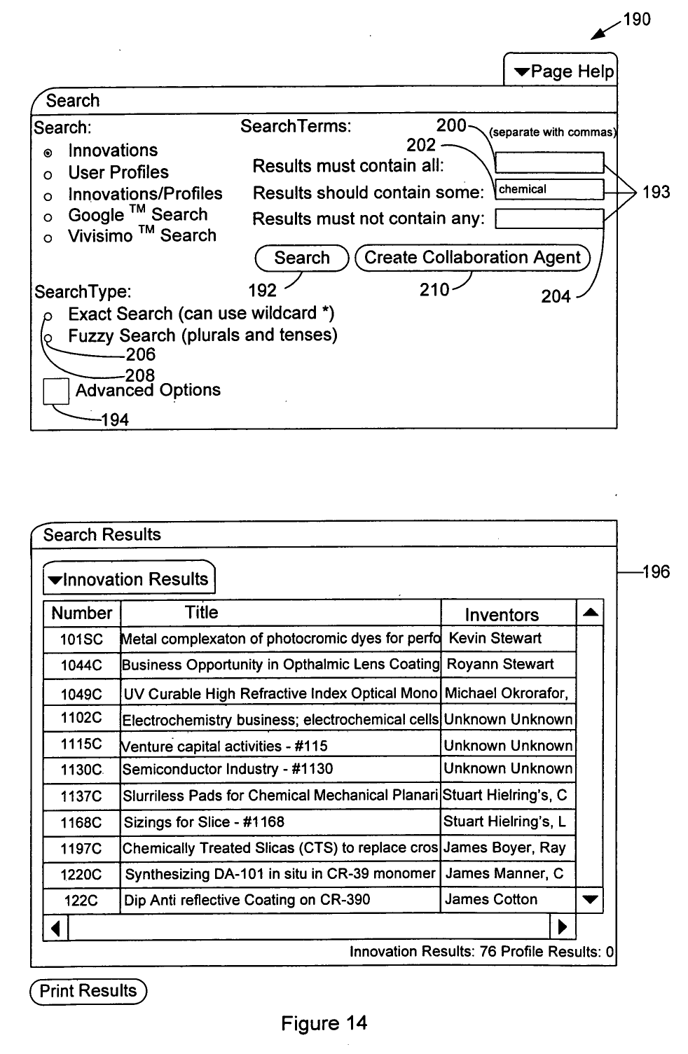

In one embodiment, the innovation management system includes a search function a user may employ to search for one or more innovation submissions or other information stored on the innovation management system. To perform a search, a user may click a displayed search link, such as the Search graphic 180 shown in FIG. 13, to receive a search display, such as the search display 190 of the FIG. 14 embodiment. The Search graphic 180, in one embodiment, is displayed in the top right corner of the user's home page on the innovation management system. The innovation management system may then provide the user with a search display, such as the search display 190 shown in FIG. 14, where the user may enter search terms in the search fields 193, and then click the Search button 192 to start searching.

In an embodiment, the search is initially designed to automatically search all information in the innovation management system for the search terms a user entered. In that embodiment, the user may click on the check box 194 labeled “Advanced Options” to receive another display (not shown) the user may employ to narrow the scope of the search. Search results may be displayed by the innovation management system, such as on the search results display 196.

In an embodiment, in order for a user to be able to conduct faster, more efficient searches, new information (for example, less than one day old) will not show up in search results. New information may be automatically indexed nightly by the innovation management system. New innovation submissions input in the innovation management system may not be displayed in search results unless they have been designated as “shared,” as described herein, by the inventor(s) or other user(s).

In an embodiment, a user employs the search display 190 of FIG. 14 by inputting the search terms, which may be words or phrases, with each word or phrase separated with a comma. Phrases may not need to include quotes (but it may be acceptable if they do), and phrases may be intermixed with single words. The search terms may be entered in one or more text areas to designate how the search is performed by the innovation management system. The user may require that search results contain all search words/phrases by inputting them in the “Results must contain all” text area 200 of the search fields 193. The user may require that search results contain some search words/phrases by inputting them in the “Results should contain some” text area 202 of the search fields 193. The user may require that search results do not contain any words/phrases by inputting them in the “Results must not contain any” text area 204 of the search fields 193. Search terms may be input into more than one of the text areas 200, 202, and 204. Search terms may not be case sensitive. The following are examples, each example in quotes, of search queries that may be entered into a text area 200, 202, or 204:

“wooden rollercoaster, swings, amusement park, city”

“golf, PGA, Arnold Palmer, golf club, tee”

“plants, test tube”

Regarding the third example, if those terms are entered in the text area 200, the management system may search the innovation submissions and associated information and other information on the innovation management system for files that include both the term “plants” and “test tube.”

A user may also designate a type of search by clicking one of the Search Type buttons 206 and 208 to further refine the search. Clicking the Exact Search button 208 may designate a search in which the innovation management system 100 will output search results that contain only the exact words entered by a user, and may enable a user to input wildcard search characters, such as an asterisk, into a text area 200, 202, or 204. For example, in an embodiment the search term “base*” would return both “baseball” and “bases” as search results. The term “base % s” and/or “base*s” would return “baseballs” and “bases,” but not “baseball,” since “baseball” does not end in “s.” The term “john*” may return “john,” “johns,” “johnston,” and “johnson.”

Clicking the Fuzzy Search button 206 may designate a search in which the innovation management system 100 will return search containing plurals and tenses of certain or all search terms. For example, such a search using the term “play” may return a search result that include “play,” “plays,” “player,” and “playing.”

Clicking the Advanced Options button 194 may provide additional search options, which may be displayed by the innovation management system. In one embodiment, the additional search options include a Search Fields option a user may click to receive a display of all fields of information within the management system and those fields may be designated to be searched by default. The user may click one or more fields and thus “de-select” those fields so the innovation management system will not search within those fields.

In an embodiment, the innovation management system conducts searches by default with respect to a portion of the information on the information management system. In this embodiment, the additional search options received in a display by clicking the Advanced Options button 194 may include an Expanded Search Fields option in which additional fields that can be searched but are not searched by the default search may be displayed and may be selected for searching by clicking the appropriate fields.

The additional search options received in a display by clicking the Advanced Options button 194 may include a Departments/Locations option. A default search of the innovation management system may return results for all departments and locations. A user may click the Departments/Locations option to limit the search results by allowing results only in certain departments or locations. For example, if a user only wanted results from one location, Pittsburgh, the user might click “Pittsburgh” from a drop-down list provided by the Departments/Locations option.

After all desired search terms have been inputted and desired search options have been designated, a user may execute the search, such as by clicking the Search button 192 to begin the search.

In one embodiment, the search display 190 includes a button 210 for creating a collaboration agent, which may allow a user to save a search permanently and/or perform other functions such as described herein in the Collaboration Agents Overview.

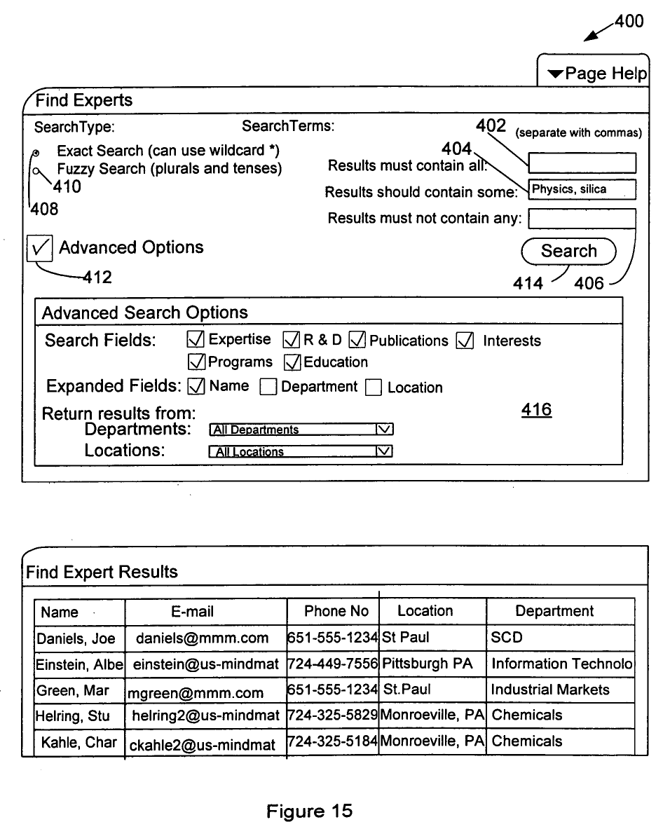

The innovation management system may also provide a link a user may select or click to receive a display, such as the find experts display 400 of FIG. 15, from which the user may create and execute a search for experts. In one embodiment, the search for experts may be configured as a Search Agent, as described herein. The link to the display the user may employ to search for experts may be found on the home page 70 of the user or another page. The user may enter search terms into the text boxes 402, 404, and 406, such as described with respect to text boxes 200, 202, and 204, respectively, of the search display 190 of FIG. 14. A user may also click the Exact Search button 408 or the Fuzzy Search button 410, which may designate the search as described with respect to the buttons 208 and 206, respectively, of FIG. 14. A user may also select Advanced Options 412 to be provided a display of additional search options, such as those shown in the Advanced Search Options area 416 and/or described with respect to the display received by clicking the Advanced Options button 194 of FIG. 14. When the user has completed input of the search criteria, he or she may activate the search for experts by clicking the Search button 414.

New Innovation Submission Overview

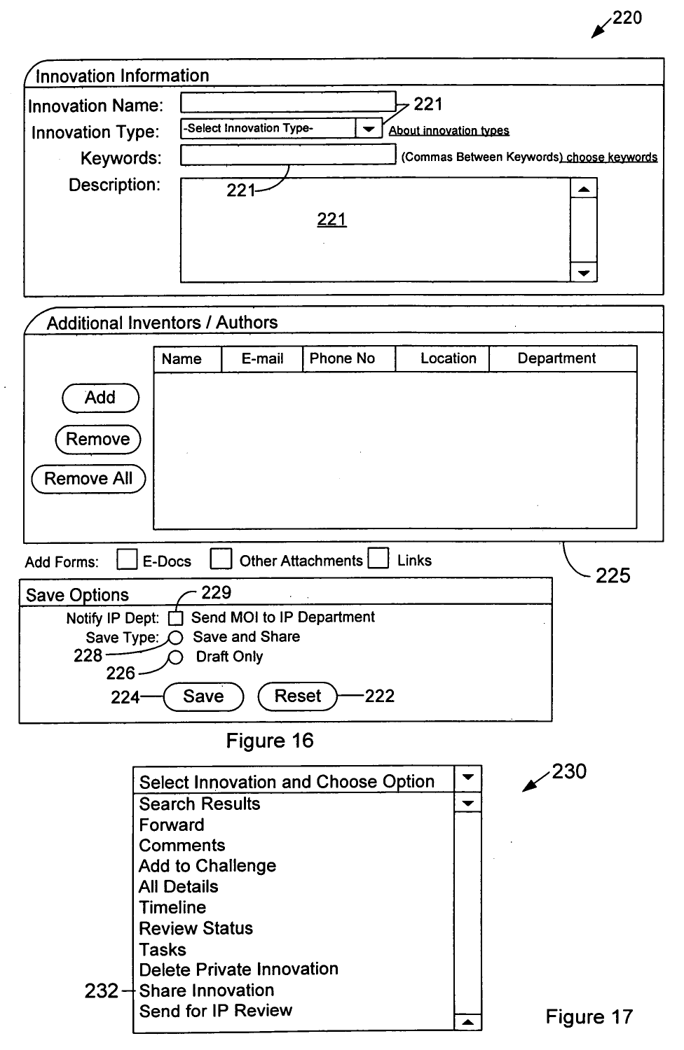

In one embodiment, the innovation management system accepts and processes innovation submissions input and submitted by users. For example, the innovation management system may include a display, such as the menu 102 of FIG. 4 with a “Submit New Innovation” text link that a user may click and then be provided a display, such as the innovation display 220 shown in FIG. 16. The user may enter and submit information concerning an innovation submission on the innovation display 220. Since each innovation and thus each innovation submission may be a work-in-progress, a user may enter as much information for the innovation submission as he or she knows, and the management system may allow the user to sometimes or always go back and change or delete information—even after an innovation submission has been submitted. The innovation display 220 may provide user input areas 221 for which information concerning the innovation may be, or in one embodiment must be, input by the user for inclusion in the innovation submission. Such user input areas 221 may be highlighted, such as with a red asterisk, to indicate to the user that information should be entered there.

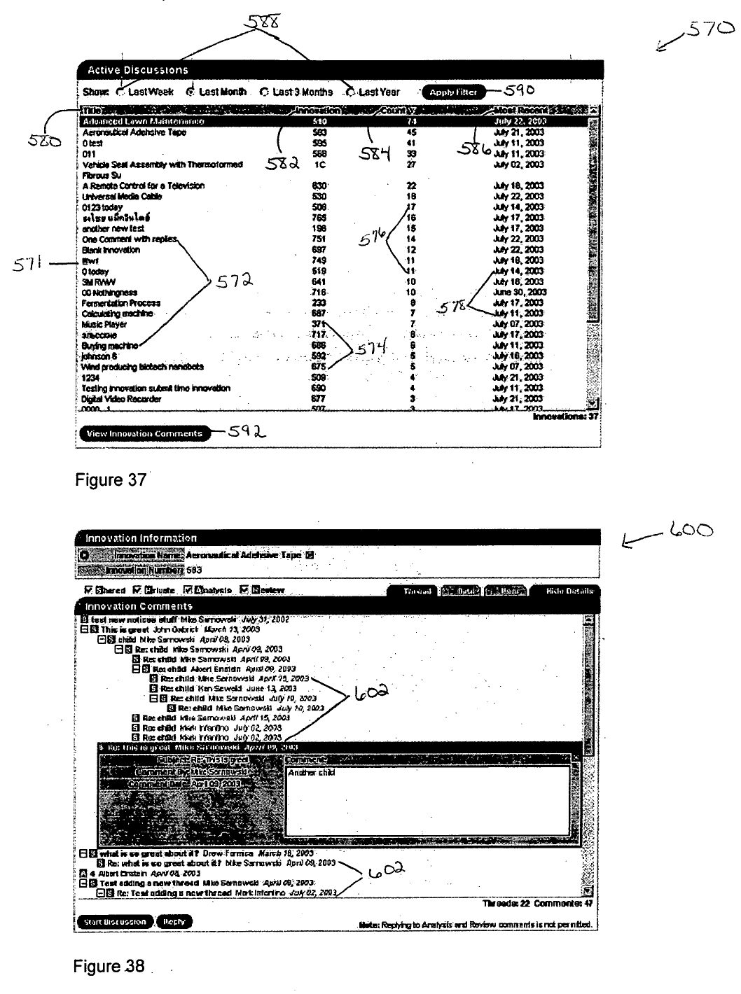

In one embodiment, the user input areas 221 include text boxes designated for a user to input or click the name, type, associated keywords, and description of the innovation associated with the innovation submission. The description may be, for example, a summary of the technology of the innovation and/or an identification or summary of the information provided in the innovation submission. This inputted information may facilitate the locating of the innovation submission through a search conducted by the innovation submission author or another user. The search may be, for example, a general search executed by employing the search display 190 of FIG. 14, a search executed through a search agent configured via a search agent configuration display 340 as illustrated in FIG. 26, a search conducted by the innovation submission author or another user for associated experts via the find experts display 400 of FIG. 15, or a search executed through a collaboration agent configured via the collaboration agent display 540 of FIG. 37.

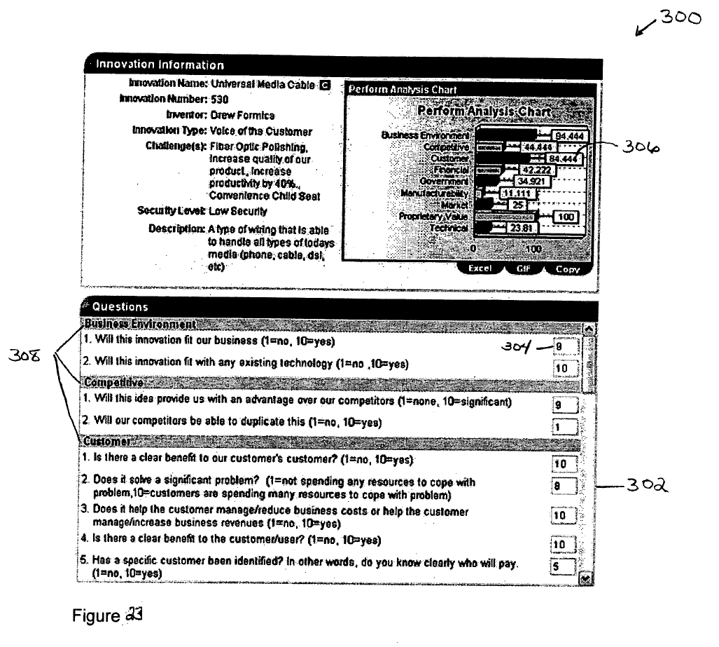

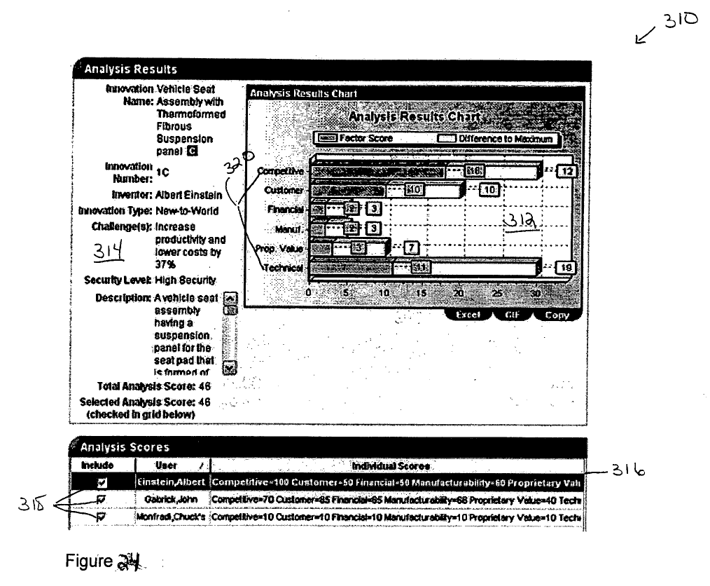

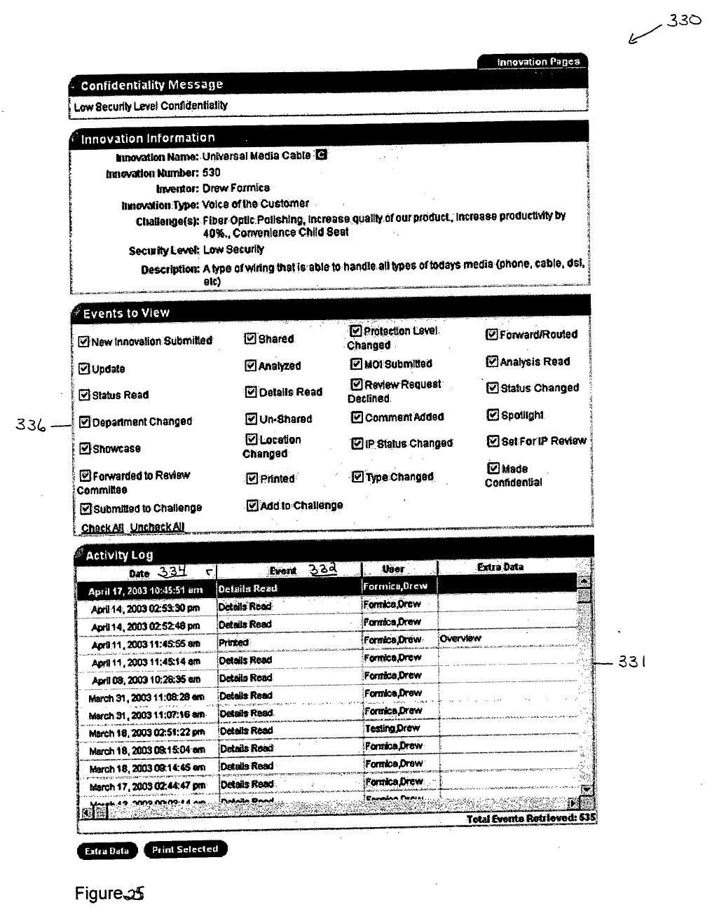

The innovation type that may be input into a user input area 221 designated for the type may be employed by the innovation management system to associate the innovation of the innovation submission with a particular set of analysis questions, such as those described with respect to the innovation information display 302 of FIG. 23. In this way, innovation submissions may be grouped together by innovation type for reporting as well as analysis comparisons, such as described herein. The innovation type may be input by clicking the Select Innovation Type drop-down list of the user input areas 221 to receive a displayed list of types from which the user may click the appropriate type. A user may receive a display that describes the types by clicking the “about innovation types” link on the innovation display 220.

Keywords that may be input into a user input area 221 designated for keywords may be words or phrases, which may be separated by commas, that help to identify the innovation associated with the innovation submission, such as through a search, and may facilitate the location of relevant experts and potential collaborators. In one embodiment, the innovation display 220 includes a link (not shown), such as a “choose keywords” drop-down list link, that a user may click to receive a displayed list of pre-entered words or phrases, each of which the user may click to add the word or phrase in the user input area 221 designated for keywords.

A user may click the Reset button 222 to clear all inputted entries. A user may click the Save button 224 to save the innovation submission, which may be saved and stored by the innovation management system, and which may be accessed by the user from a display, such as the from the “My Innovations” link of the menu 102 of FIG. 4. The menu 102 may be displayed as part of the user's innovation management system home page.

Several options may be associated with saving. For example, two radio buttons 226 and 228 may be clicked by a user to save an innovation submission either as private or shared, respectively. Private submissions, which may be in draft form, may be submitted by clicking the radio button 226 before clicking the save button 224. The submitter, for a private submission in one embodiment, clicks the button 228 or performs another operation the management system provides before pressing the save button 224 to “share” a submission as described herein, which may start the formal review process. Shared innovation submissions may be non-private and viewable by some or all other users who have access to, and possibly appropriate security privileges in, the innovation management system. Choosing to share a submission may begin the review process by the organization of the user as well as saving the user's submitted innovation information.

If the organization to which the user belongs desires to use the innovation management system to collect, from the innovation submissions, invention disclosures or other information that may be relevant to the Intellectual Property rights the associated innovation may secure, the innovation management system may provide, as another saving option, an optional checkbox 229 to either send or notify the Intellectual Property department or other appropriate person or persons of the organization to which the user belongs that the submission should be reviewed from a legal perspective.

In one embodiment, an administrator or other user may customize the innovation display 220 or another display a user may employ to submit an innovation submission to the innovation management system. In this embodiment, the administrator may edit, remove or add user input areas 221, buttons such as the buttons 222, 224, 226, and 228, checkboxes such as the checkbox 229, and any other displays desired, such as one or more of the displays described herein.

FIG. 20 illustrates an options link drop-down menu 230 that, in one embodiment, is displayed, such as on a user's home page or on a page that includes the innovation display 220, and may be employed by a user to perform various functions in connection with a new innovation submission. The options link drop-down menu 230 may include a list of options a user may click to perform the options in connection with a new innovation submission. The options may include, as described herein, viewing the results of one or more searches performed in connection with an innovation submission, commenting on an innovation submission, adding a previously submitted innovation to a challenge, viewing all details related to an innovation submission, viewing a timeline of submissions of material related to an innovation submission, reviewing the status of an innovation submission, considering tasks performed or to be performed in connection with an innovation submission, deleting an innovation submission that has been kept private and that, in retrospect, does not seem of significant value, sharing an innovation submission with others, or sending an innovation submission for intellectual property review.

In this embodiment, before a user selects one of the options, the user selects an innovation submission for which the option will be performed. For example, the drop-down menu 230 may be displayed on a page with the innovation display 220 of FIG. 16. In this example, after the user has submitted an innovation submission by employing the innovation display 220, the user may click an option on the drop-down menu 230 to perform the option with respect to the innovation submission. In another example, the user may employ the My Innovations display 260 of FIG. 20, described below, to click or otherwise highlight an innovation submission listing 261 and then click an option on the drop-down list 266 to perform the option on the innovation submission.

Innovation submissions may be submitted to a particular department or person for review by, for example, selecting the innovation submission, then selecting the “Forward” option from the options link drop-down menu 230 and selecting the appropriate recipient person or department from the drop-down menu. A user may, thus, submit an innovation submission that is an early rendition of an innovation to another user immediately for feedback. The user may alternatively or additionally develop the innovation over time and add a more complete embodiment to the innovation submission and submit that rendition to another user for feedback.

In one embodiment, the innovation submission may be automatically designated to be submitted to a department and/or location when saved. The department or person may be designated for each user by an administrator or other user. In another embodiment, a “Submit to” option (not shown) may be included on the innovation display 220 and may be clicked by a user to receive a drop-down list of departments and/or locations, one or more of which the user may click to designate where or to whom the innovation submission will be submitted.

Attaching Electronic Documents

In one embodiment of the innovation management system, if a user has already drafted an electronic document describing his or her innovation, or if the user has other electronic documents, such as spreadsheets, drawings, scanned images, source code, or other information or material in electronic form, the user may attach one or more of the documents for inclusion in the innovation submission. Attaching these documents may create a permanent record of the innovation with a time/date stamp, which may, for example, support a date of invention for purposes of patentability or ownership. The documents may be securely stored and recorded on the innovation management system, such as on a server, and may be available on the innovation management system should the originals be lost or destroyed.

To attach electronic documents, a user may click the “E-Docs” checkbox on the innovation display 220 to receive a display, such as the Electronic Documents display 243 shown in FIG. 18. The user may click the “Browse . . . ” button 249 of the Electronic Documents display 243, causing a selection window 240 to open, and documents can be located in the same manner as with other Microsoft Windows™ applications or applications associated with any operating system. When the user has located the document, he or she may single-click or otherwise highlight the document listing and click the Open button 242, or double-click the document listing, and the corresponding document will be selected and the window may automatically close.

To remove attached documents, the user may click the documents in the area 244 of the Electronic Documents display 243 and then click the Remove button 246. The Remove All button 248 may be clicked to delete all documents or all documents shown. All electronic documents that are currently attached to the innovation submission may appear in the area 244.

In one embodiment, to submit an innovation submission, the innovation management system requires the user to input a brief description of the corresponding innovation. Even if the attached documents contain a more complete description, the user may have to add a brief description on a submission form, such as the innovation display 220 of FIG. 16. The brief description may include an innovation name, innovation type, keywords, and a description, and may be input in the corresponding areas 221 of the innovation display 220. The brief description may be searchable and may facilitate collaboration and understanding of the innovation associated with the innovation submission.

Because the attached documents may be confidential, the innovation management system, in one embodiment, only allows searches, such as searches for innovation submission information as described with respect to FIGS. 14 and 15, to be performed on the brief description of the innovation submission, and not on information in the attached documents. The brief description therefore, in this embodiment, may facilitate collaboration and understanding of the innovation of the innovation submission without divulging confidential information.

Attaching Non-Electronic Information

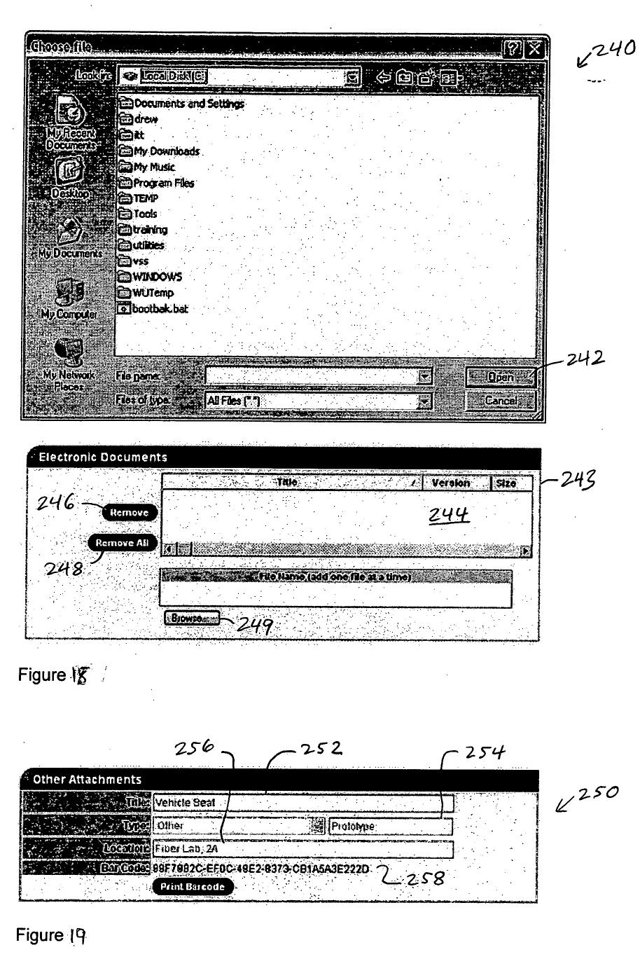

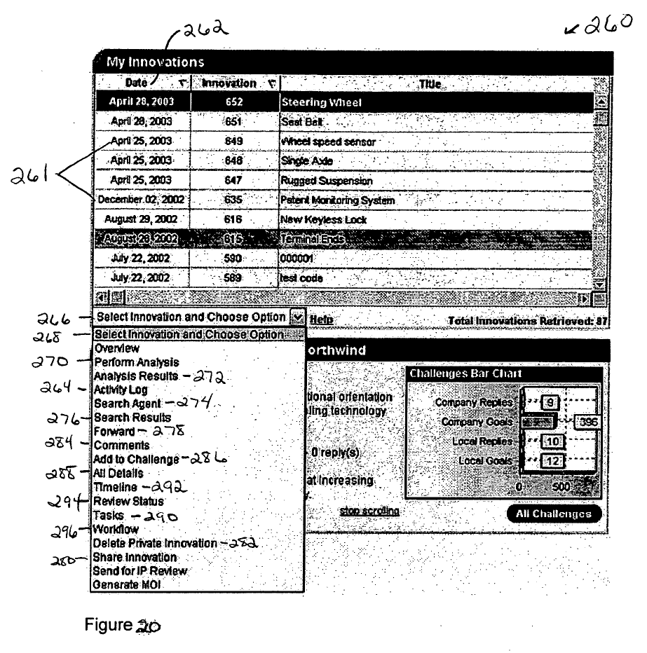

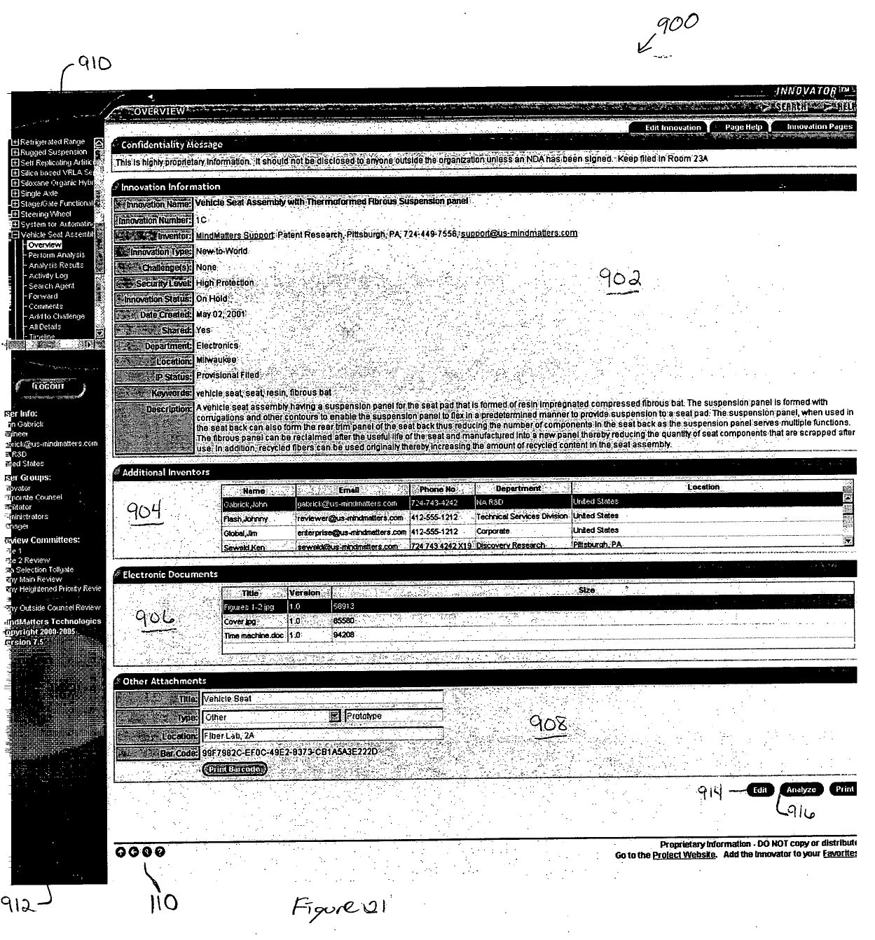

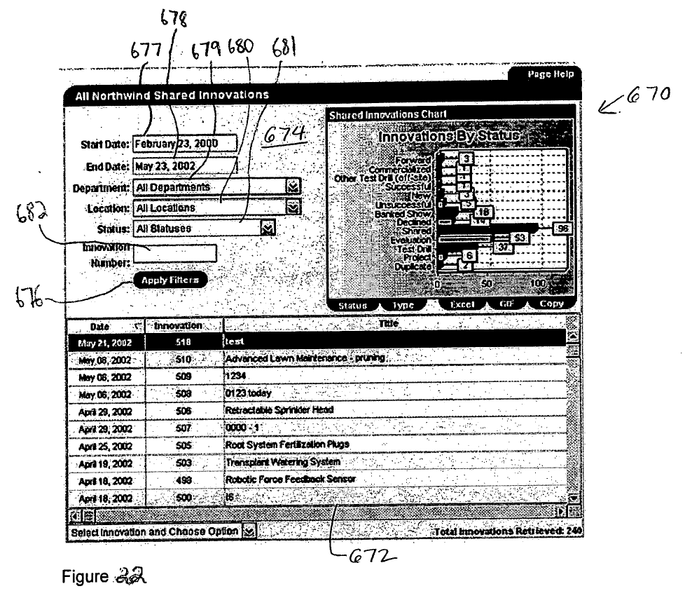

In one embodiment, the innovation management system is employed by a user to notate non-electronic information for inclusion in an innovation submission. In this embodiment, if a user has written a hard-copy description of an innovation, or has other non-electronic or tangible documents, such as prototypes or hard-copy versions of spreadsheets, drawings, or source code, the user may attach information associated with any or all of this non-electronic matter, such as a title, type, location, and/or a barcode or other unique reference for each matter, to the innovation submission. To attach non-electronic information, a user may click the “Other Attachments” checkbox on the innovation display 220 to receive a display, such as the Other Attachments display 250 shown in FIG. 19, in which a user may input each non-electronic matter's title in the title area 252, select an attachment type by clicking the drop-down list 254, and enter the location in the location area 256. When the user submits his or her innovation, a unique barcode 258 may be automatically created for each non-electronic matter by the innovation management system. The user may be able to print the barcode by clicking the button 259 and may then attach the barcode to the associated non-electronic matter.

Links

A user may also add links, such as links to websites, files, or directories of files, to the innovation submission. In one embodiment, the user may click the “Links” checkbox of the innovation display 220 to receive a display (not shown). From that display, the user may select an “Add” button. Then, from a drop-down list, the user may click “URL” to receive a display in which the user may enter a description and address for the website to be linked. The user may click “File” or “File Location” from the drop-down list to receive a display from which the user may select the file or directory to be linked, such as by clicking a “Browse” button to open a Windows dialog box or other display from which the user may select the file or directory. After the link or links have been added, the user may click a “Save” button to save all links to the innovation submission.

Private/Shared Innovation Submissions

In one embodiment, each time a user submits an innovation submission associated with his or her innovation, its status is set by the innovation management system to “private.” Private innovation submissions may be saved and stored in the innovation management system, but may not be viewed by anyone, including managers or review committee members, except the submitter user. That user may access the private innovation submission, such as by clicking the “My Innovations” link on the menu 102 of FIG. 4, which may be displayed on the home page of the user and/or one or more of the other displays described herein. Private innovation submissions may be sent to anyone the user chooses for review, but may not be viewed or returned in a search performed by anyone other than the user.

In one embodiment, where a private innovation submission is associated with multiple users, such as where the associated innovation has multiple inventors or authors, those multiple users may each access the innovation submission via the innovation management system. In this embodiment, anyone other than one of the multiple users may not access the innovation submission.

Conversely, in one embodiment, everyone with the appropriate security privileges provided by the innovation management system may view “shared” innovation submissions. As part of the process of submitting a “shared” innovation submission, the innovation management system may be set to forward that innovation submission to appropriate review committees, individuals, or other groups of users as determined by a distribution policy. The distribution policy may be created in the innovation management system by the organization to which the user belongs or another user. In an embodiment where innovation submissions are designated by default as “private” as described above, the user who submits the innovation submission may change that designation to “shared.” The user may change the designation to “shared” by, for example, selecting an innovation submission via the “My Innovations” link of the menu 102 of FIG. 4 and then clicking a “Share Innovation” link, which the innovation management system may display, for example, as the option 232 of the drop-down menu 230 of FIG. 17. Clicking the Share Innovation button 232, in an embodiment, may prompt the innovation management system to provide a step-by-step process a user may follow to share the submitted innovation, such as described herein.

In one embodiment, to determine whether a user has designated one of his or her innovation submissions as private, the user views the innovation submission listing 261 under a column labeled “Shared” (not shown) in his or her “My Innovations” display 260 as illustrated in FIG. 16 and which may be accessed by clicking the “My Innovations” option of the menu 102 of FIG. 4. A “Yes” under that column may indicate that the innovation submission is shared, and a “No” may indicate that the innovation submission is private.

In an embodiment, the innovation management system may provide a display, such as the menu 102 of FIGS. 3 and 4 on a user's home page or other display described herein, that includes an “all shared innovations” link a user may click to receive another display, such as the shared innovations display 670 of FIG. 22.

The shared innovations display 670 provides listings 672 of all shared innovation submissions the user is eligible to receive. Eligibility may depend on the security privileges of the user or other criteria such as described herein. The user may filter and thus limit the displayed listings 672 by employing one or more filter options 674 and then clicking the Apply Filters button 676. For example, the user may enter one or both of a start date and end date associated with the innovation submissions in the areas 677 and 678, respectively. In one embodiment, the start date and end date designate, respectively, the date in which the user originally input the innovation submission into the innovation management system and the date the innovation submission was last edited by the user. The start date and end date may alternatively designate other dates. A user may employ one or more of the Department link 679, Location link 680, and Status link 681 to receive drop-down lists (not shown) from which the user may click a listed option to filter the displayed innovation submission listings by user/author department, user/author location such as “Pittsburgh,” and innovation submission status, respectively. A user may enter one or more innovation submission numbers, as described herein, in the area 682 to restrict the displayed innovation submission listings to those of the entered numbers.

The user may click one of the displayed descriptions 672 to receive a display of the corresponding innovation submission. In one embodiment as shown in FIG. 21, that display includes the Innovation Submission Overview page 900. That page may include an Innovation Information Area 902 that provides information of the innovation submission, such as, for example, one or more of the following: an innovation name, an innovation number, names of any inventors or authors, an innovation type, associated challenges, the security level, the innovation status, the date created, an indication of whether designated as “shared,” a department, a location, a status of intellectual property protection activity, associated keywords, and an innovation description.

The Innovation Submission Overview page 900 may also include an Additional Inventors Area 904 that provides listings of users, other than the user who submitted the innovation submission, who may be inventors and/or authors of the innovation submission.

The Innovation Submission Overview page 900 may also include an Electronics Documents Area 906 that includes listings of electronic documents that have been attached as part of the innovation submission.

The Innovation Submission Overview page 900 may also include an Other Attachments Area 908 that identifies non-electronic documents that are notated as part of the innovation submission, such as described in the “Attaching Non-Electronic Information” section above.

In one embodiment, some or all of the information in the Innovation Information Area 902, Additional Inventors Area 904, Electronics Documents Area 906, and Other Attachments Area 908 may have been added by the user who submitted the innovation submission, such as via the innovation display 220 of FIG. 16.

The Innovation Submission Overview page 900 may also include other displays, such as the navigation menu 910, which may be employed such as the navigation menu 102 of FIG. 4, the User Information Display 912, which may present information such as provided in the User Information Display 170 of FIG. 12, an Edit Innovation button 914 that a user may click to edit the innovation submission, an Analyze button 916 that a user may click to analyze the innovation submission such as described herein, navigation buttons such as the navigation buttons 110 of FIG. 6, and a search graphic such as the Search graphic 180 shown in FIG. 13. The Innovation Submission Overview page 900 may include additional, fewer, or different displays, such as one or more of the displays described herein.

Entering/Deleting/Changing Inventors

In one embodiment, the innovation management system assumes that for any innovation submission a user submits, the user is the inventor or author. To add other inventors or authors, a user may add the other inventors or authors to be included in the user's innovation submission. The innovation display 220 may include an Additional Inventors/Authors display 225 that includes an “Add” button a user may click to receive another display for adding inventors or authors. This other display may be the User Name Lookup display 1000 of FIG. 47, which may provide a list of users of the organization to which the user belongs.

The User Name Lookup display 1000 may automatically retrieve and display a list of all the users of the innovation management system and display them as the users 1012. In order to reduce the list of users 1012 to a more manageable number, a user may click or use one or more of the drop-down lists 1002, 1004, 1006, and/or 1008 under Departments, Locations, User Groups, and Review Committees, respectively, to view the corresponding choices. When a user clicks one or more choices from any of these drop down lists, the management system may revise the list of users 1012 to include only those users who meet the clicked criteria. For example, if a user selected “Pittsburgh” from the Locations drop-down list 1004 and clicked the Apply Filter button 1010, then only the people who were located in Pittsburgh may be shown.

Once a user finds one of the users 1012 he wishes to add, the user may click the name or names and then click the Select button 1014, and the management system may automatically add a listing of the person or persons to the Additional Inventors/Authors display 225. The Select All button 1016 may be clicked to add all the users 1012. The user may click the Close Window button 1018 when the user is finished selecting users 1012 to close the display 1000. This process may be repeated if more inventors or authors need to be added.

The user may remove one or more inventors or authors from the Additional Inventors/Authors display 225 by clicking or otherwise highlighting one or more of the inventors or authors listed and then clicking the “Remove” button of the Additional Inventors/Authors display 225. A user may remove all inventors or authors listed by clicking the “Remove All” button of the Additional Inventors/Authors display 225.

In another embodiment, where a user has already submitted an innovation submission, the user may change the listed authors or inventors. In this embodiment, the user may access the My Innovations display 260 of FIG. 20, click or otherwise highlight one of the innovation submission listings 261, then select an option, which may be called “Inventors/Contributors,” from the drop-down list 266 to receive the additional inventors display 1020 of FIG. 48. In the display 1020, the user may click one or more of the users from the inventors or authors 1022 and then click the Remove button 1024. The user may also clear the entire list of the users 1022 by clicking the Remove All button 1026. The user may also click the Add button 1028, to receive the User Name Lookup display 1000 of FIG. 47, from which the user may add inventors or authors as described above.

My Innovations Overview

The innovation management system may provide a display for each user, such as the My Innovations display 260 shown in FIG. 20, where the user may view a display of listings of, and may access, the stored innovation submissions he or she has input. Innovation submissions that are shared may be indicated with a “Yes” displayed in a column labeled “Shared” (not shown). Conversely, if there is a “No” in the column labeled “Shared,” then the user or users associated with the innovation submission, such as by inventorship, may be able to view the innovation submission.

In the embodiment of FIG. 20, to sort innovation submissions, a user may click on any of the column titles for the innovation submission listings 261, such as the date column 262, and the innovation submission listings 261 may be automatically sorted. Clicking on the column again may sort the column in reverse order. In addition, a user may change the width of individual columns by centering his or her mouse in between the columns and waiting for the mouse to change to a vertical line ‘|’, then pressing the mouse button and dragging the column to the desired width. Column titles may be rearranged in any order by a user by clicking and holding his or her mouse on a column and then moving it to the desired location.

The date shown under the date column 262 may be the date the user originally submitted the innovation submission, or another date. The display 260 may also include a Status column (not shown), which may indicate the current status of the innovation submission. To get more detailed status information, a user may click the Activity Log option 264 from the drop-down list 266, which may be displayed near the bottom of the display 260, to receive, in one embodiment, the Activity Log display 330 of FIG. 25. The display 260 may provide an area or link in which a user may search for an innovation submission, and may include a Search Agent option 274 that indicates that a search agent has found a match or matches. To get more search agent result details, the display 260 may provide a Search Results option 274 a user can click from the drop-down list 266 to receive another display, such as the Search Agent Results display 370 of FIG. 27.

Overview

The innovation management system may include an option a user may employ to view details of an innovation submission. In one embodiment, the drop-down list 266 of the display 260 provides an Overview option 268 that a user may click, after the user highlights an innovation submission listing 261, to receive a display, such as the Innovation Submission Overview page 900 of FIG. 21 in one embodiment, in which the user may view the details of a particular innovation submission. In the embodiment of FIG. 21, the user may click the Edit Innovation button 914 to edit the innovation submission. In one embodiment, clicking the Edit Innovation Button 914 provides an innovation submission edit display that includes the innovation display 220 of FIG. 16 or another display where the user may view, edit, including adding, changing, and deleting information. Edit, save, and print buttons may be included in the innovation submission edit display embodiment. In an embodiment where the Edit button is included, the user clicks the edit button (not shown) to receive a display, such as the innovation display 220, that shows the innovation submission and allows the user to edit it. In another embodiment, clicking the Edit Innovation Button 914 to make the Innovation Submission Overview page 900 editable.

In one embodiment, some fields of innovation submission information are not changeable, such as the date field. During the editing process, a user may add new electronic documents to the innovation submission. In order to preserve the original form of the documents submitted earlier as part of the innovation submission, those documents may not be changed when a user adds new documents-even if the document name is the same. Thus, the innovation management system may automatically determine if the file name of a new document is the same as one already submitted, and if so, may automatically create a new version without deleting the original.

When the user is finished editing, the user may click the Save button, such as the Save button 224 of the innovation display 220 of FIG. 16, to save the changes for storage in the innovation management system. A user may click the Print button to cause a hardcopy of the information of the innovation submission to be printed at an attached, network, or other printer. In one embodiment, when the user clicks the Print button, he or she receives another display (not shown) which includes options the user may click to designate the scope of information of the innovation submission the user wishes to print.

Perform Analysis

The innovation management system may provide an option for a user to perform an analysis of an innovation submission. In one embodiment, where a user wants to perform an analysis of a particular innovation submission, the user may find and click the innovation submission, such as an innovation submission listing 261 in the display 260 of FIG. 20, then click the Perform Analysis option 270 button of the drop-down list 266 or another displayed button to begin the analysis. In an embodiment where an innovation submission has been e-mailed to the user with a request to perform an analysis, the user may click the innovation submission description to begin the analysis. In one embodiment, where an innovation submission has been forwarded to a user by another with a request to perform an analysis, the user may click on a link to that innovation submission in the status window 150 of FIG. 10 to begin the analysis.

The innovation management system may, to initiate the analysis, display information regarding the innovation submission, such as that of the display 300 of FIG. 23, and may display a series of questions, such as those of the display 302 of FIG. 23. In an embodiment, questions change based on the stage of analysis or development an innovation submission is in or the user who is performing the analysis. The questions may be determined and input by an administrator or other user.

In one embodiment, different sets of questions are provided for performing different analyses of the innovation submission. In this case, an additional field, which may be labeled “Question Sets,” may be shown along with a drop-down list of selections. A user may select the question set using the drop-down list and input answers to these questions, and when completed, the user may select another question set from the drop-down and input answers to those questions. A user may navigate to the next question by pressing the <Tab> key, using a mouse or by other means.

For a questions set, a user may be asked to answer with a “yes” or “no,” or with a number such as a number between 1 and 5, or other answer criteria. Answer criteria may be designated by an administrator of the innovation management system or another user. In one example, for each question, the user may enter any number between 1 and 5, including decimals. In one embodiment, a “1” may represent the lowest possible score to a question, and a “5” may represent the highest possible score. The answers for different questions may be the same, but may be different in different situations. For example, the question “Do you add chemical preservatives to your product during the manufacturing process” may have a “1” for no, “5” for yes as answers for a innovation submission product where potential customers may be concerned about shelf-life and spoilage, whereas the same question might have “1” for yes, “5” for no as answers for an innovation submission product where potential customers may be allergic to certain food additives.

In one embodiment, a user may enter a score in the form of a number, such as a number between 1 and 10, even for questions that could have yes/no answers. For example, a user may think the answer to a question is “yes,” but may not strongly agree, in which case the user may enter a 9, such as in area 304 of FIG. 23. A user may disagree with a question, but instead of answering 1 as a strong “no,” the user may enter 2 where the user does not disagree completely.

As the user enters each answer, the innovation management system may record the results and display them in the bar graph 306. Thus, if a user answers all questions under one of the analysis factors 308 with the highest scores, the bar graph 306 may display a “100” or other indicia of the highest score for that analysis factor 308. In one embodiment, a the innovation management system processes the scores provided by all participating users to the analysis questions for a particular innovation submission and computes the average score for each question. Thus, if a first user enters the highest score for each question under an analysis factor 308, the innovation management system may average those scores with scores provided by other users and display the average score, which may be less than the highest score, in the bar graph 306. For example, if with respect to an analysis of one innovation submission, a user answers a particular question with a “5,” and another user answered the same question with a “2,” then the innovation management system would compute an average 3.5 and may display that average on the bar graph 306.

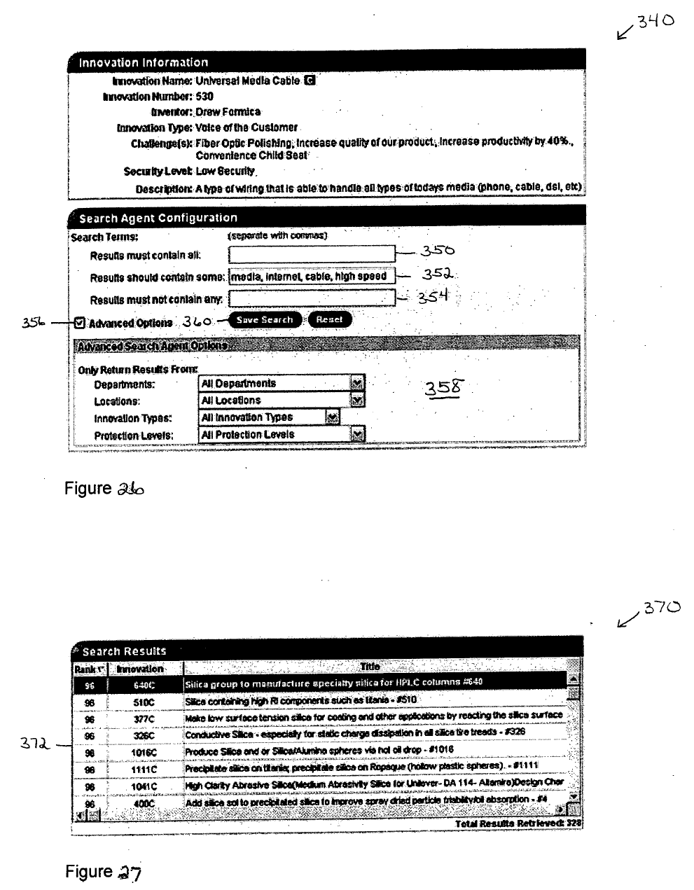

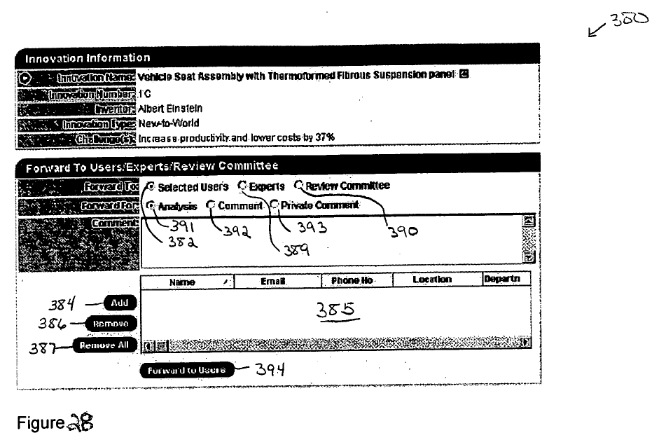

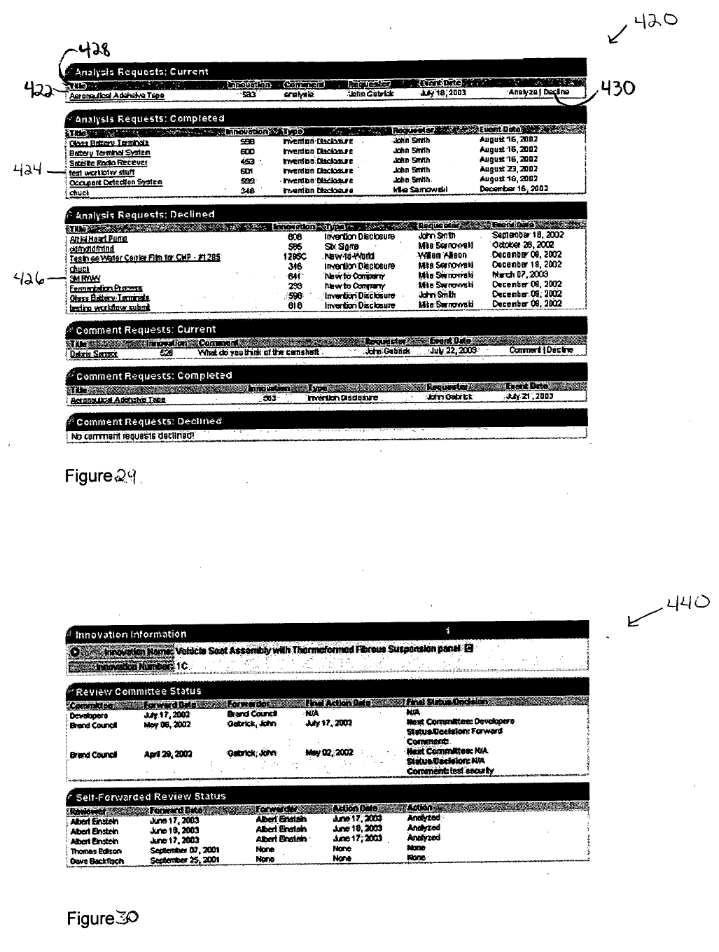

In another embodiment, the questions under an analysis factor 308 may be weighted such that a score provided for one question may affect the average score for the analysis factor 308 more, less or the same as another question. An example of how the management system may weight questions is provided below with respect to the analysis, results display 310 of FIG. 24.

In another embodiment, if a user does not know the answer to a question or prefers not to answer, the user may leave the answer area, such as area 304, blank. Questions with blank answers may not be considered in determining an average for purposes of the bar graph 306.

In one embodiment, a user may input comments, such as described with respect to the Discussion/Comments Overview section herein, along with answers, if desired, into a comments text box (not shown).

When the user has answered the questions, the user may save the answers, such as by clicking a Save button (not shown).

View Analysis Results

The innovation management system may include an option a user may click to receive a display of analysis results, which may be a summary overview of all of the analyses that have been performed on an innovation submission. In one embodiment, the drop-down list 266 may provide an Analysis Results option 272 that may be clicked to prompt the innovation management system to display the analysis results. In one embodiment, this display is the analysis results display 310 shown in FIG. 24, which includes a graphical representation, the overall scores display 312, of an average or weighted average of analysis scores provided by all users, a display 314 of information concerning the associated innovation submission, and a display 316 of the individual scores each user submitted. The highest score for each analysis factor 320, in one embodiment, is 100. In one embodiment, the overall scores display 312 or another display shows an “innovation value score” that represents an average of the average or weighted average scores of all the analysis factors. This “innovation value score” may provide some indication of the value of the innovation of the innovation submission, with a higher score indicating greater potential value.

In an embodiment, a user performs what-if scenarios on the average or weighted average scores by unchecking one or more of the boxes 318 in the “Include” column of the display 316 for the users who have performed an analysis. The innovation management system may then revise the overall scores display 312 to show the average or weighted average scores of the users whose boxes are left checked, and, in one embodiment, the innovation value score for those average or weighted average scores.

In an embodiment, some innovations have been analyzed using different sets of questions. In this embodiment, when a user first views the analysis results, the overall scores display 312 may show the aggregate average or weighted average scores for each set of questions. A user may click or otherwise select the analysis factor (not shown) the user wishes to view, and the overall scores display 312 or another display may then display the average scores for each of the questions of an analysis factor, along with a list of the users who performed the analyses and which questions each answered.

In an embodiment, the scores a user inputs as answers to analysis questions are weighted in the display 312 by an administrator or other user according to strategic priorities. For example, with regard to analyses of an innovation submission regarding a product, an administrator or other user may weight the questions under a “Financial” analysis factor based on the importance of each question relative to the others in predicting the profit margin of the product.

In another embodiment, the analysis factors may be weighted, such as according to strategic priorities, alternatively or in addition to the weighting of the questions within the analysis factors. In this embodiment, the innovation management system computes an average or weighted average score for each analysis factor, then determines an innovation value score weighting each analysis factor as a percentage of “1” such that the total weighting is 100%. The innovation management system may then add the weighted averages of the average or weighted average scores of the analysis factors to determine an innovation value score, which will be a number from 1 to 100, where a higher number indicates a greater potential value for the corresponding innovation.

In an example of an embodiment for computing average weighted scores of analysis factors, if a user enters the highest scores as answers to equally-weighted questions under an analysis factor 308, the bar graph 306 of FIG. 23 may display the score for that analysis factor as the highest score, such as “100.” However, if that analysis factor is given a weight of 30%, the score may be shown as 30% of 100, or “30.” If other users also submitted answers to questions under that analysis factor, the score for that analysis factor on the display 312 may be less than “30.” The innovation value score may be determined by adding the values of all analysis factors 320 and, if desired, dividing the result by the number of users to determine an average score.

In another example of weighted scoring, the innovation management system may provide a question set for analyzing an innovation submission, the question set having two analysis factors, Marketing and Technical, the Marketing factor having a 30% weight and the Technical factor having a 70% weight. Each factor in this example includes two questions for which a user answers from 1 to 10, as described below:

Marketing:

Q1. How large is the market? (The user answers “5”);

Q2. Is it a good market? (The user answers “10”);

Technical:

Q1. Is this a good technology? (The user answers “8”);

Q2. Is it easy to make? (The user answers “2”).

The innovation management system is set in this example such that the total score for each analysis factor is a number between 1% and 100% based on the answers. If both marketing questions had been answered with a “10,” the overall Marketing score would have been 20 out of a possible 20, or 100%. In the example above, however, the Marketing score was (5+10)=15 out of a possible 20, or 75%. The weighted Marketing score would then be 30% of the 75%, or 22.5%. The weighted Technical score in this example is (8+2)/20*70% weighting, or 35%. The overall weighted score in this example is then 22.5%+35%, or 57.5%. This score may determine a predicted potential value of the innovation submission, with a higher score indicating a greater value.

Activity Log

The innovation management system may automatically track and display, such as in the Activity Log display 330 of FIG. 25, activity log information 331 regarding these various activities in association with an innovation submission of a user. The activities may include, for example, information or a link from an event column 332 regarding analyses and/or other information input by the other users, information or a link from a date column 334 regarding the identity of and time when another user performed an analysis of and/or viewed the innovation submission, information regarding a status change another user input, and the amount of activity. The activity information may provide the user who provided the innovation submission with feedback concerning the innovation, as well as the identity of other users who, may have expertise or wish to collaborate in the innovation of the innovation submission.

The innovation management system may include an option, such as the Activity Log option 264 of the drop-down list 266 of FIG. 20 that a user may click to receive the Activity Log display 330 of FIG. 25. In one embodiment, checkboxes 336 are provided by the Activity Log display 330 and may be clicked by a user to designate the type of information to be provided as activity log information 331. A clicked (checked) checkbox 336 next to a type of information description may designate that the type be displayed as part of the activity log information 331, and a checkbox 336 clicked as unchecked may designate that the corresponding information type be not displayed.

Search Agents

The innovation management system may include an option a user may click to create “search agents.” Search agents may be search “helpers” that search the innovation management system for information regarding innovation submissions of others that are similar to one or more of a user's innovation submissions, such as those shown, in one embodiment, in the My Innovations display 260. The innovation management system may, in one embodiment, match information in a user's innovation submission, such as the information input by the user as part of his or her innovation submission via the innovation display 220 of FIG. 16, with similar information included in the innovation submissions of others. Search agents may thus find submitted innovations of other users that are duplicates of a user's innovation submission, or may find areas of overlap or areas in which a potential exists for collaboration between the user and the other users.

In one embodiment, the drop-down list 266 of the My Innovations display 260 of FIG. 20 includes a Search Agent option 274 the user may click to receive the display 340 of FIG. 26, from which a user may input a search agent search. In one embodiment, a user enters search terms into one or more of the text areas 350, 352, and 354 under the rules that the terms would be entered into the text areas 200, 202, and 204 as described herein with respect to the search display 190 of FIG. 14.

The display 340 may also include an Advanced Options button 356 that may be clicked to provide additional clickable options 358, which may include those provided by, and described with respect to, the Advanced Options button 194 of FIG. 14, and vice versa. The options 358 may further define the search. For example, the options 358 shown in the display 340 may be clicked to limit the search agent to search for information on the innovation management system submitted by users in certain organization departments and/or locations, limit the information regarding a certain type of innovation, and limit the information that has a protection level such that the information may only be accessed by users with the requisite security access privileges.

After a user has input the search terms and/other search criteria, the user may click the Save Search button 360 to save any changes made to the search agent. A user may click the Reset button 362 to reset the search agent to its original state, which may be the state, in one embodiment, in which that search agent was last saved.

The innovation management system may activate search agent searches periodically. Thus, the search may be repeated automatically, such as once a day or at another frequency. In an embodiment, the frequency and time that search agents are activated may be set by an innovation management system administrator or other user.

A user may quickly determine, in one embodiment, whether a search agent has located new information by clicking the Search Agents heading 159 of the status window 150 of FIG. 10 or the “Search Agents” option on the function selection menu 106 of FIG. 5 to receive a display (not shown) that may indicate whether the search agent has located new information.

In an embodiment, each time a user submits a new innovation submission, the innovation management system may automatically configure a search agent to search for and output similar information found in innovation submissions of other users based on the brief description, such as the information described with respect to the areas 221 of the innovation display 220 FIG. 16, that the user entered in association with the new innovation submission. The user may disable the search agent function in one embodiment, such as by clicking a button (not shown) on the innovation display 220 before clicking the Save button 224. After the innovation management system performs its initial search, it may periodically search its database for new similar innovation information using the same search criteria. This periodic searching may notify a user of any new information that may be similar to the innovation of his or her innovation submission.

Search Agent Search Results

The innovation management system may output search results found by search agents. In one embodiment, the drop-down list 266 of the My Innovation display 260 of FIG. 20 includes a Search Results option 276 a user may click to receive a display of those results, such as the Search Agent Results display 370 of FIG. 27. Search agents may be associated with a particular innovation of the user who created the search agent, and thus the search results may be relevant to the innovation submission of the user. In one embodiment, to see the results for a particular innovation submission, a user clicks or otherwise highlights the innovation submission listing and clicks the Search Results option 276 from the My Innovations display 260, which may be displayed on the home page of the user. The innovation management system may display lists of innovation information results 372, such as in the display 370, that match the search agent search terms and other criteria. A user may click any of the innovation information results 372 to view an overview of the innovation information, such as is illustrated in FIGS. 23 and 26. In an embodiment, each innovation information result 372 provides information from one innovation submission of another user.

Forward

In one embodiment, the innovation management system provides a function a user employs, such as by clicking a Forward option 278 in the drop-down list 266 of the My Innovations display of FIG. 20, to initiate the function of forwarding an innovation submission to a peer, supervisor, team member, review committee, and/or any number of other users for their review.

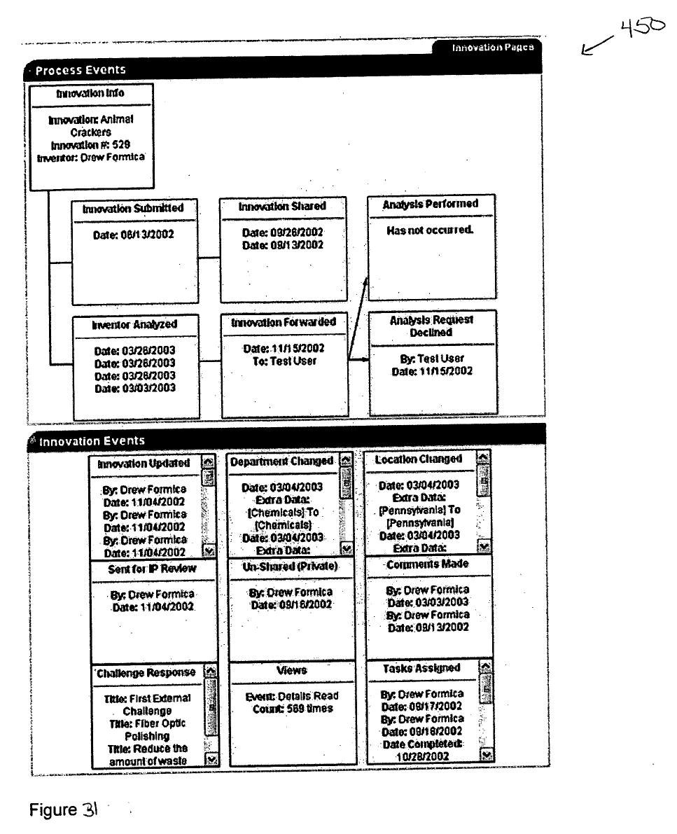

In one embodiment of the innovation management system, a user may click an innovation submission listing, such as one of the innovation submission listings 261 of the My Innovation display 260 of FIG. 20, that the user wishes to forward. The user may then click the Forward option 278 from the drop-down list 266 to receive a display, such as the Forward to Users/Experts/Review Committee display 380 of FIG. 28. To forward the designated innovation submission for review, a user may click the Selected Users button 382. A user may then click the Add button 384 to be provided a display of a list of all users of the innovation management system. Clicking the Add button 384 may result in a display such as the display 1000 of FIG. 47, and a user may add other users as described herein with respect to the display 1000. Listings of the added users may appear in the area 385. A user may also remove users by clicking the user listing in the area 385 and then clicking the Remove button 386. To remove all users in the area 385, a user may click the Remove all button 388.

To forward the innovation submission information to one or more experts, a user may click the Experts button 389 and then click another button, such as a “Find” button (not shown). The innovation management system may then search stored information regarding users who have expertise that matches the brief description of the innovation submission, such as the keywords, description, and/or other information input into the areas 221 of the innovation display 220 of FIG. 16. The stored information regarding users or others may be information those users input, or had input on their behalf, for their user profiles, such as the user profile shown in the My Profile display 650 of FIG. 42. The innovation management system may display identities and/or other information of users having the matched expertise. The user may click the expert or experts (not shown) to which the user wishes to forward the innovation submission information.

To forward the innovation submission to one or more review committees, a user may click the Review Committee button 390, which may provide a drop-down list or other display (not shown) from which the user may click the review committees to which he or she wishes to forward the information.

In one embodiment, that innovation management system provides an option for a user to designate a privacy level and type of review for which the innovation submission is being forwarded. In this embodiment, the user may designate the innovation submission to be forwarded for analysis by clicking the Analysis option 391 to request that the analysis be performed by the designated other users on the innovation. The user may click the Comment option 392 to request that the other users only input a comment regarding the innovation. The user may click the Private Comment option 393 to request that the other users only input a comment regarding the innovation and that the comment and the innovation submission information be kept confidential by all involved users.

The user may then click on the Forward to Users button 394 to forward the innovation submission to the designated user or users. In one embodiment, the forwarding of the innovation submission is forwarding of a link the recipient user may click to receive a display of the innovation management system from which the user may perform the designated type of review.

Share Innovation

In one embodiment, the drop-down list 266 of the My Innovations display 260 of FIG. 20 includes a Share Innovation option 280, which may be clicked after clicking or otherwise highlighting one of the innovation listings 261 to designate the innovation as “shared,” such as described with respect to the Share Innovation option 232 described with respect to FIG. 17.

Delete Private Innovation

The innovation management system may provide an option to delete a private innovation submission. In one embodiment, to delete a private innovation submission, a user clicks or otherwise highlights the innovation submission listing in the My Innovation display 260 of FIG. 20, then clicks the Delete Private Innovation option 282 from the drop-down list 266. In one embodiment, the management system prohibits a user from deleting a shared innovation without authorization, which may be provided by an administrator or other user.

View Comments

The innovation management system may allow users to input comments and/or discussion information regarding a shared innovation submission of a user. The innovation management system may provide an option for a user to view the comments and/or discussion related to an innovation submission, such as described in the Discussion/Comments Overview section herein. In one embodiment, the drop-down list 266 of the My Innovations display 260 of FIG. 20 provides a clickable Comments option 284 that enables the viewing of comments or discussion with respect to an innovation submission that may be designated by clicking or otherwise highlighting an innovation submission listing 261. In another embodiment, the user may click the “all comments” text link shown in the navigation menu 102 of FIG. 4 or the “comments” text link shown in function selection menu 106 of FIG. 6 to receive a display of the comments associated with an innovation submission currently being displayed.

In an embodiment, clicking the Comments option 284 after highlighting an innovation submission description 261 will result in a display from which the user may view and input comments. In one embodiment, the display is the comments display 600 of FIG. 38, and a comment may be added as described herein with respect to the comments display 600.

In another embodiment, comments that were not submitted by the user for a discussion of an innovation submission may be viewed by the user by employing the display 570 of FIG. 37, as described herein.

Add to Challenge

The innovation management system may provide the functionality for which an administrator, manager of an organization of users, or another user may create a challenge. A challenge may be a problem that needs to be solved, and may be related to one or more focused areas of innovation an organization of users is currently addressing. Challenges may be strategic, tactical, technical, or business issues that may bring value to an organization of users if they are met. This value may be in the form of cost savings, better market performance, and/or increased revenues, for example. Challenges may come from any user or group of users of the organization, and may be first transmitted to the users that the challenge author believes to have the best chance of meeting the challenge. A user may submit to a challenge, such as if the user believes he or she may be able to meet the challenge

During the creation of the challenge by a user, the innovation management system may prompt the user to input the numbers of responses he or she hopes to receive. These numbers may be collected and aggregated by the innovation management system, and may be displayed in the display 166 of the FIG. 11 embodiment. In one example, the display 166 displays the numbers of responses hoped to be received both organization-wide and locally, such as by a specific office of the organization.

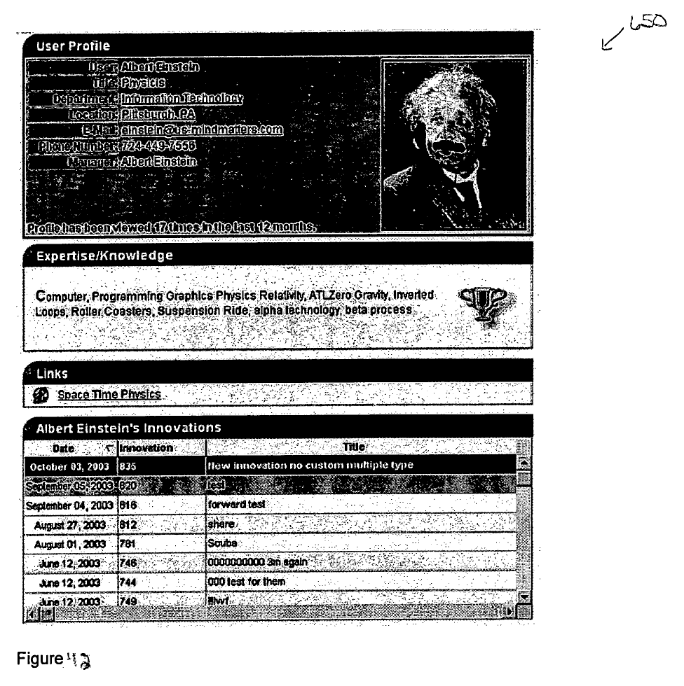

The innovation management system may also provide an option for a user to submit one of his or her innovation submissions to a challenge, such as a challenge 160 discussed with respect to FIG. 11. In one embodiment, a user clicks or otherwise highlights the appropriate innovation submission listing 261 of the innovation submission in FIG. 20 and then clicks the Add to Challenge option 286 in the drop-down list 266. Clicking the Add to Challenge option 286 may result in another display, such as the display 620 of FIG. 40 in one embodiment, from which the user may find the challenge listing 622 of the challenge to which he wishes to submit the innovation submission. The user may then click the Add to Challenge link 624 beside the desired challenge listing 622 to add the innovation submission to the challenge.

In one embodiment, before clicking the Add to Challenge link 624, the user may sort the challenge listings 622 by department of users by clicking the Department link 626 or by location of users by clicking the Location link 626 to view challenges provided by a department or location. The user may, for example, wish to submit the innovation submission to a challenge provided by his or her organization department or the location in which he or she works.

In an embodiment, a user may, from the display 160 of FIG. 11, click one of the titles 164 of the challenges to receive a display, such as the Challenge Details display 640 of FIG. 41, that shows more details on the challenge as well as listings 642 of all innovation submissions already submitted to the challenge. In another embodiment, a user may click one of the challenge listings 644 of the Current Breakthrough Challenges display 646 of FIG. 41 to receive the Challenge Details display 640 to view details of the selected challenge. The innovation management system may also include a display of a link, such as “all comments” text link on the navigation menu 102 of FIG. 4, that the user may click to receive the display 646 After clicking one of the challenge descriptions 644, the user may click the Add My Innovation to Challenge button 648 to receive another display (not shown) from which the user may input the new innovation submission into the innovation management system and submit it to the challenge. After clicking one of the challenge descriptions 644, the user may click the “Submit to Challenge” button to receive a display, such as a display that includes the innovation display 220 of FIG. 16 or another display, that the user may employ to input and add information, such as a new innovation submission or a comment, to the challenge.

All Details

The innovation management system may provide an option for a user to receive some or all details associated with an innovation submission including status information, other inventors, comments, complete analysis results, attached electronic documents, attached miscellaneous and/or nonelectronic items, and other innovation submission information. A user may receive a display of this information, in one embodiment, by clicking the All Details option 288 from the drop-down list 266 of the My Innovations display 260 of FIG. 20, and may also print the information to a default or other printer. In one embodiment, the display of this information includes some or all of the information shown in the Innovation Submission Overview page 900 of FIG. 21.

Take Snapshot

The innovation management system may provide an option to store or “freeze” information regarding an innovation submission in its current state. By employing this option, the innovation management system may preserve this information by storing it as a permanent record. The innovation management system may, in one embodiment, prevent this stored information, which may be called a “snapshot,” from being altered. A user may access and compare previous snapshots to determine changes to the innovation submission. The original innovation submission information may continue to be editable.

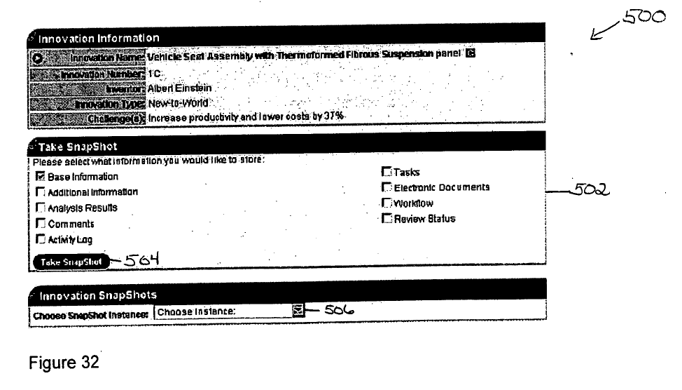

In one embodiment, a user may preserve, or take a “snapshot” of, his or her innovation submission at a certain date and time by clicking or otherwise highlighting the innovation in the My Innovation display 260 of FIG. 20, then clicking the “Snapshot” option (not shown) from the drop-down list 266. Clicking the Snapshot option may result in another display, such as the display 500 shown in FIG. 32, that provides options 502 regarding the scope of information the user may designate to be preserved, and may include a Take Snapshot option 504. The Take Snapshot option 504 may be clicked by the user to preserve the designated innovation submission along with a date/time stamp that details the time and date the innovation submission was preserved. A user may retrieve that snapshot or another snapshot regarding that innovation submission by clicking the Instance option 506 and clicking the listing of desired snapshot from the drop-down list (not shown). The snapshots may be listed by the date and time they were taken.

In one embodiment, a user may take a snapshot of an innovation submission of another user.

In one embodiment, the innovation management system provides the option to notarize the snapshot in order to create a third-party record of the innovation submission. In one embodiment, to notarize the snapshot, a user clicks the “Notarize Snapshot” option (not shown), which may be included in the drop-down list 266 of FIG. 20. Once notarized, a user may be able to employ an option to download the notarization file to provide some proof of the notarization. The notarization file may not contain any of the data from the innovation submission, and may contain, for example, a computer-generated string that refers to the innovation submission.

Tasks

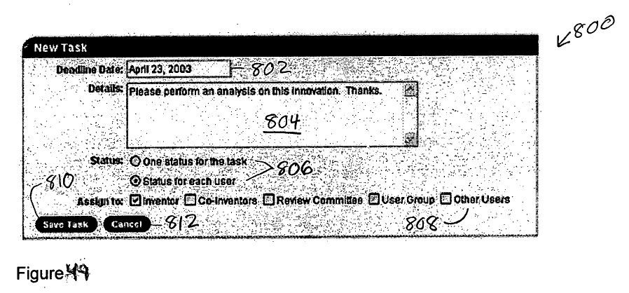

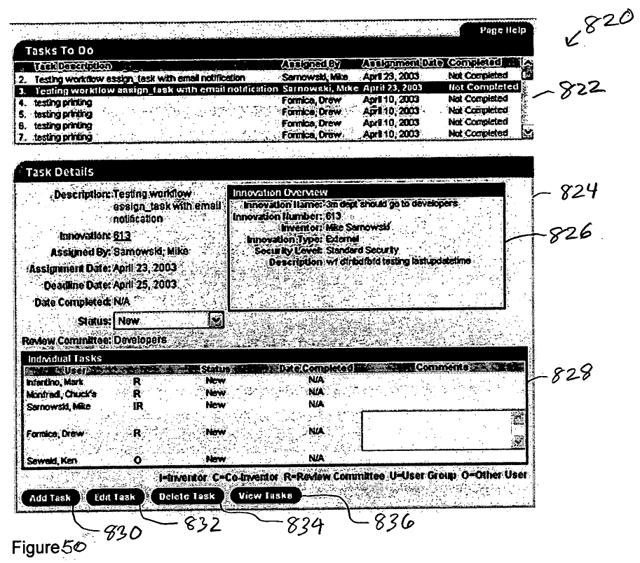

The innovation management system may provide a display of tasks associated with an innovation submission. The innovation management system may also provide an option, which may be initiated via a clickable Tasks option 290 from the drop-down list 266 of FIG. 20, for a user to create tasks associated with innovation submissions. Clicking this option after clicking an innovation submission listing 261 may result in a displayed page, such as the new task page 800 of FIG. 49, from which the user may add, edit, and delete tasks, or view the status and percentage completed of the tasks.

The new task page 800 may be employed to assign one or more tasks to individuals such as inventors, groups such as review committees and others having access to the innovation management system. Tasks may include actions created automatically by way of instructions executed by a processor of a computer node or by a user. Where tasks are created automatically, those tasks may be based on workflow rules or other rules created by a user or crated automatically.

Each task may be associated with a particular innovation submission or line of related innovation submissions. Once created, each task may be forwarded to a user or group of users of the innovation management system and may appear in a user home page or elsewhere to inform the user or users that the task has been assigned. The task may include a description of a task that the user is requested to perform, an indication of or link to the innovation submission the task is related to, and a due date when it is requested that performance of the task be completed. The tasks may also indicate whether, for example, only one user in a group needs to complete the task or whether more than one or every user in the group needs to complete the task.

Referring again to the embodiment illustrated in FIG. 49, that page may be reached from any desired page including, for example, the home page by, for example, selecting the new task page 800 from a drop-down menu. When a new task is being created, a due date may be entered in the field labeled “Deadline Date.” A description of the task to be performed may be entered in the “Details” field. Either “One status for the task” or “Status for each user” may be selected in the status area 806 to indicate whether only one assignee need complete the task or all assignees need to complete the task. The user or users to whom the task is being assigned may be selected at 808 and a listing of relevant inventors, co-inventors, review committees, user groups, or other users may appear after that selection is made to choose the relevant people or groups. At 810, a save task button may be selected to save the new task and, if desired, forward the task to the assignees. At 812, a cancel button may be selected to remove all information entered into the new task.

FIG. 50 illustrates a “tasks to do” display 820. Tasks assigned to a person, whether individually or in connection with others, may be displayed for that person in such a tasks to do display, which is referred to as a “My Tasks” display (not shown) in an embodiment of the innovation management system. Tasks assigned by a person or group of people to others may be displayed to the assignors in an assigned tasks display (not shown), along with related information such as date of assignment, due date, and status of task where the assignees may provide feedback regarding their progress on the task. Statuses may include, for example, “new” for newly assigned tasks, “completed” for completed tasks, and “in progress” for tasks assigned to multiple people and completed by the individual viewing the task.

Referring to FIG. 50, that page may be reached from any desired page including, for example, the home page by, for example, selecting the tasks to do display 820 from a drop-down menu. A task listing 822 includes a list of tasks that have been assigned to a user, whether individually or with others. A task may be removed from the list when it has been marked completed by the assignee or the assignor. Other users may also view a task listing for a particular user if they are associated with the innovation submission and have appropriate security access privileges, for example.

A task details section 824 may display information related to a task selected in the task listing 822. The task details may include, for example, a description of the task, an identifier of an innovation submission to which the task relates, the assignor of the task, the date the task was assigned, the due date for completion of the assigned task, the date the task was completed, the status of the task, the review committee having oversight over the task, and an innovation overview 826 or other information describing an innovation submission to which the task is related. Any other information desired or a subset of the information shown in FIG. 50 may be included in the task listing 822.

An innovation tasks section 828 may list tasks related to the selected innovation submission. Each task listing in the innovation tasks section 828 may include a name of an individual or group to which the task has been assigned, a status of the task a date the task was completed, and comments related to the task.

Tasks may also be administered from the tasks to do display 820. for example, a task may be added by, for example, selecting an “Add Task” button 830, a task may be edited by, for example, selecting an “Edit Task” button 832, a task may be deleted by, for example, selecting a “Delete Task” button 834, or task details may be viewed by, for example, selecting a “View Task” button 836.

Timeline

The innovation management system may display a graphical representation of the status and completed activities associated with an innovation submission, as well as an indication of what steps are required and/or next. In one embodiment, a user clicks the Timeline option 292 from the drop-down list 266 of the My Innovations display of FIG. 20 to receive this display. The display may include some or all of the information shown in the timeline display 450 embodiment shown in FIG. 31.

Review Request

When a user has been requested to perform an analysis or make a comment on an innovation submission, a message may be displayed on the user's home page, and the user may link to the request, such as by clicking the Review Requests heading 152 of the status window 150 of FIG. 10. The resulting display of the requests may include the Requests display 420 of FIG. 29 in one embodiment. The Requests display 420 may include the status of requests, such as a Current area 422 that lists all of the requests that have not been completed by the user, a Completed area 424 that lists all of the requests the user has finished, and a Declined area 426 that lists requests that the user decided not to review. In one embodiment, the display of the requests may include a link that may be clicked to view requests that the user has made of one or more other users.

To review a request, a user may click the appropriate link under the title column 428 to automatically be taken to the appropriate page for making a response. If the user will be performing an analysis of an innovation submission by answering questions, the user may be shown a page which includes displays such as the display 300 and Questions display 302 of FIG. 23. If the user is to add a comment regarding an innovation submission, the user may be shown a page such as shown and described herein with respect to Comments display 600 of FIG. 38. After the user has completed the request, the listing of the request in the display 420 of FIG. 29 may be deleted automatically by the innovation management system.

Where a user does not wish to perform an analysis or make a comment regarding a specific innovation submission, the user may decline the analysis or comment, such as by clicking the Decline link 430. By declining, the innovation submission listing may be automatically deleted by the innovation management system and the status of the innovation submission may be automatically updated to reflect the decline.

Review Committees

As part of the process of an organization of a user evaluating innovation submissions, a user's innovation submission may be transmitted in the innovation management system to review committees for their input. Review committees may be managers or administrators of an organization to which a user belongs, or may be other users. A user may or may not be able to forward his or her innovations directly to the committees. A user may be able to check on the status of the review process. To check on the status of an innovation submission, a user may click a link of an innovation submission listing, such as a description 261 of the My Innovation display 260 of FIG. 20, then click the Review Status option 294 from the drop-down list 266. Clicking the Review Status option 294 may link to a display of the status of review, such as the display 440 of FIG. 30.

Personal Statistics

In an embodiment, the innovation management system may provide incentives to users to participate in connection with an innovation submission. For example, the innovation management system may automatically assign rewards, such as “award points,” to a user for certain types of participation. Administrators or other users may employ the innovation management system to designate the types of user participation for which the awards will be assigned, as well as the amount of award for each type. The reward designations may be called “reward rules.” The rewards may be assigned to a user for active participation, such as the inputting of an innovation submission or the input of analysis regarding another user's innovation submission. Rewards may be assigned to a user for non-active participation, such as the searching for or inputting of comments to innovation submissions, or the inputting of comments by others in association with an innovation submission of the user. This rewards program may be similar to airline frequent flier programs whereby a flyer receives points for flying to certain cities, participating in various programs, or purchasing different products.

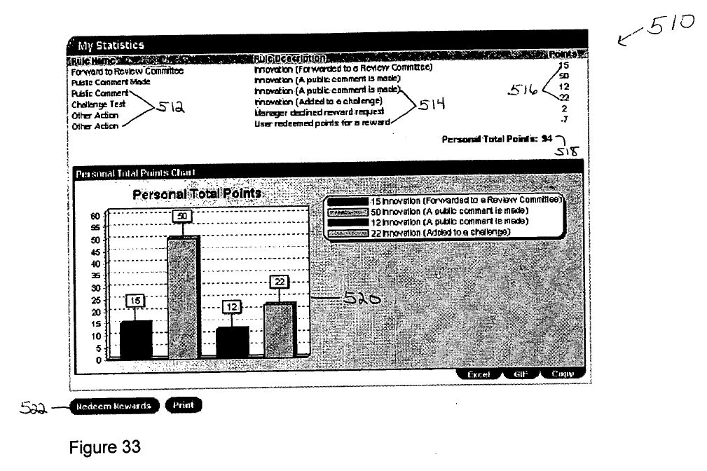

The innovation management system may automatically track user participation and aggregate the points or other reward criteria when a user action performed in the innovation management system matches a reward rule. The innovation management system may automatically collect basic statistics about user participation within the innovation management system, including award points or other rewards, and display the statistics. The statistics display may include, in one embodiment, the display 510 of FIG. 33. In this embodiment, the display 510 displays names 512 and descriptions 514 of the rewarded actions a user took, the points 516 the user received for each action, and the total reward points 518 the user has received. The display 510 may also include a chart 520 that provides a breakdown of the accumulated points by user participation type. The innovation management system may also provide an option for a user to redeem the points or other rewards he or she has received. In the embodiment of FIG. 33, a user may click the Redeem Rewards button 522 to receive a display (not shown) of the products, services, or other awards for which he or she may redeem the points or other rewards.

Education Center Overview

In one embodiment, the innovation management system provides an option to store and access educational information in the innovation management system. Administrators and/or other users may input the information or a link thereto by employing the option. The educational information may include, for example, information a company/organization believes may provide education on intellectual property. The information may include the intellectual property goals and procedures of the company/organization, as well as links to other information sources.

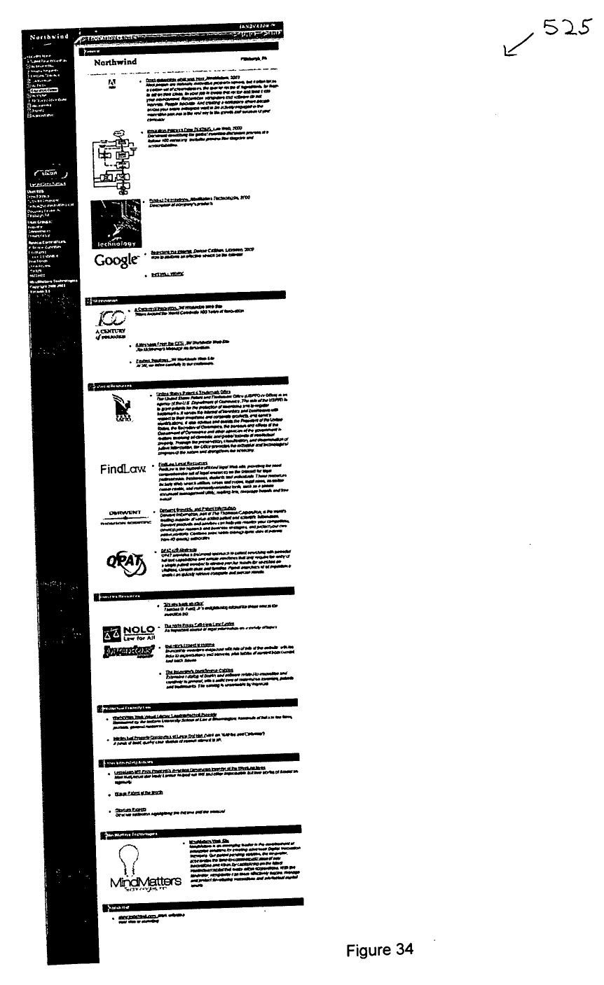

The innovation management system may provide an option users may click to access the educational information and receive a display of the information, such as the display 525 of the FIG. 34 embodiment.

Collaboration Agents Overview

The management system may provide the functionality for a user to activate automatic, user-directed searches of the some or the entire innovation management system database. These searches may be set to automatically recur, such as once a day in one embodiment. These searches, which may be called “collaboration agents” in one embodiment, may differ from search agents in that search agents may be attached to, and return results based on, a specific innovation submission, whereas collaboration agents may not be associated with a specific innovation submission. For example, a user may employ a collaboration agent to generally search for new camping locations, bicycles, semiconductor experts, or chemical formulae. When the collaboration agent “finds” information newly input into the innovation management system on bicycles, for example, the innovation management system may automatically provide this information or links thereto to the user, such as on the user's home page. The search agent may thus keep a user current on happenings on a technology within the innovation management system without requiring the user to continuously instigate a search for that technology.

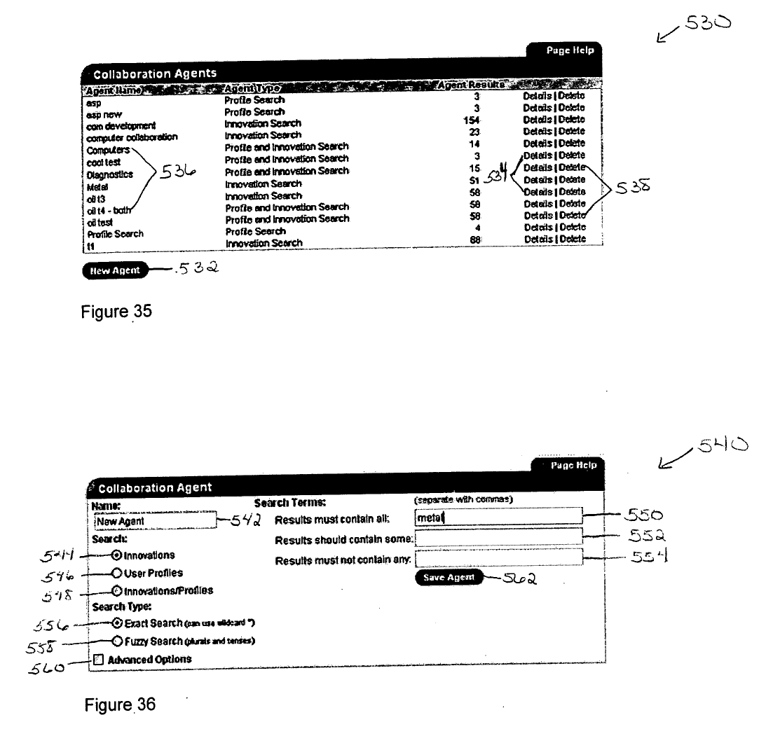

The innovation management system may provide a display, which may be accessed by clicking the “Collaboration Agents” text link of the navigation menu 102 of FIG. 4 or the Collaboration Agents heading 154 of the status window 150 of FIG. 10 or another link, from which a user may create a collaboration agent. The display may be, in one embodiment, the Collaboration Agents display 530 of FIG. 35, from which a user may click the New Agent button 532 to receive another display, such as the Collaboration Agent Search display 540 of the FIG. 36 embodiment.

In the FIG. 36 embodiment, a user may input a name of the collaboration agent in the area 542. The name may be the type of information the user would like to search for, such as “New Kitchen Appliances,” or “Stereo Speakers.” In an embodiment, once the name has been entered, it is not editable. The search agent may exclusively search within user profiles, such as described with respect to FIG. 42, innovation submissions, or both, by clicking the Innovations button 544, User Profiles button 546, or the Innovation/Profiles button 548. In one embodiment, a user must click one of those buttons or the innovation management system will not accept the created collaboration agent. A user may enter search terms into the text boxes 550, 552, and 554, such as described with respect to text boxes 200, 202, and 204, respectively, of the search display 190 of FIG. 14. A user may also click the Exact Search button 556 or the Fuzzy Search button 558, which may designate the search as described with respect to the buttons 208 and 206, respectively, of FIG. 14. A user may also click the Advanced Options button 560 to be provided additional search options, such as those described with respect to the Advanced Options button 194 of FIG. 14. When the user has completed inputting the search criteria, he or she may save the search agent, such as by clicking the Save Agent button 562.

The innovation management system may provide a display from which a user may view and change an already configured collaboration agent. Returning to the embodiment of FIG. 35, a user may click the Details button 534 beside a search agent name 536 to receive another display that provides details of the search, and from which the user may edit the associated search agent. This other display may be the Collaboration Agent Search display 540 of FIG. 35 in one embodiment, and may show the search terms and options the user last saved for the search agent. The user may edit the display 540, such as by changing the search terms and/or options, then pressing the Save Agent button 562 to prompt the innovation management system to employ the search agent as edited.

The innovation management system may provide an option to delete a search agent. In one embodiment, a user clicks a Delete button 538 beside a search agent name 536 to delete the search agent from the innovation management system. The innovation management system may display an additional option a user must click to confirm deletion. The innovation management system may also provide a link a user may click to receive a display from which the user may create or edit a search agent to search for experts. The display may include, in one embodiment, the display 400 of FIG. 15 and its functionality, except the search button 414 may be a Save Search button.

A user may view search results found by the collaboration agent by, for example, clicking a search agent name 536 from the Collaboration Agent Search display 530 of FIG. 35.

Discussion/Comments Overview

The innovation management system may provide the functionality for a user to view and add comments on all innovation submissions that are shared by other users and for which the user has security access privileges.

The innovation management system may display a link a user may click to receive a display of discussions, which may be groups of comments input in association with specific innovation submissions. The link may be found, for example, in a display received by clicking the Collaboration Agents heading 154 of the status window 150 of FIG. 10 in one embodiment, or may be found on another page, such as the home page of the user.

In one embodiment, the discussion display includes the display 570 of FIG. 37. The display 570 may show a list of innovation submission descriptions 571 that have the “most recent” and/or “most active” associated discussions. Each innovation submission description 571 may include a title 572, an innovation submission number 574 that may denote the chronological order the innovation submission was input with respect to all other innovation submissions, the number 576 of comments input for the discussion, and the date 578 of the most recent discussion input, or may include some of this information and/or other information. A user may click a table heading, such as the table heading Title 580, Innovation 582, Count 584, or Most Recent 586 to sort the list by that table heading. Clicking the Title table heading 580 may sort the innovation submission descriptions 571 alphabetically by title. Clicking the Innovation 582 and Count 584 table headings may sort the innovation submission descriptions 571 by Innovation and Count number, respectively. Clicking the Most Recent table heading 586 may sort the innovation submission descriptions 571 chronologically by most recent comment input in the discussion.

In one embodiment, the innovation management system provides an option to filter the list of innovation submission descriptions 571, such as by clicking one of the buttons 588 and then clicking the Apply Filter button 590. For example, clicking the “Last Month” button 588 and then clicking the Apply Filter button 590 may result in a display of only innovation submission descriptions 571 for which comments have been added to the discussion within the preceding month. Other buttons (not shown) may be clicked to filter the results, such as by discussion start dates, end dates, and innovation submission listings 571 for innovation submissions input by a certain user. A user may view the comments of a discussion for an innovation submission by clicking one of the innovation submission descriptions 571 and then clicking the View Innovation Comments button 592, which may result in a display such as the display 600 of the FIG. 38 embodiment.

Viewing Comments

There may be multiple types of comments that may be added in association with an innovation submission. Comments may include one or more of the following types: shared comments, private comments, analysis comments, task comments, and status change comments.

Shared comments may be public and may be made or viewed with respect to an innovation submission by any user who has security access privileges to view the innovation submission. Security access privileges for a user may be designated by an administrator of the innovation management system or another user, or may be set to a default level by the innovation management system when a person is included as a user.

Private comments may be associated with an innovation submission, and may each be accessible by only the innovation submission author(s) or inventor(s) and possibly its recipient or other users designated by the author(s) or inventor(s). Analysis comments, which may be optional and may be associated with an innovation submission, may be made by a review committee member or other user who is analyzing the innovation submission. Analysis comments may not be accessible by some or most users. Status change comments may be optional and may be made in association with an innovation submission when a user, such as a company manager, review committee member, or other user changes the status of the innovation submission. Task comments may be made by a user in association with a task.

In one embodiment, a user may submit a search for an innovation submission, such as by employing the search display 190 of FIG. 14, the display 340 of FIG. 26, or the display 540 of FIG. 36. In another embodiment, the innovation management system may provide a display, such as the menu 102 on a user's home page or one of the other displays described herein, that includes an “all shared innovations” link a user may click to receive a display, such as the display 670 of FIG. 22 as described herein, of all shared innovation submissions the user is eligible to receive. Eligibility may depend on the security level of the user or other criteria as described herein. The user may, in either the search results display or the display of all shared innovation submissions, click an innovation submission description to receive a display of the innovation submission, which may include a “view comments” or other link. The user may click that link to view all shared comments associated with that innovation submission. In one embodiment, the shared comments may include one or both of analysis comments and status change comments.

Adding Comments

The innovation management system may provide an option a user may click to add a comment to any of the shared innovation submissions. To find a shared innovation submission, a user may employ a search, search agent, or collaboration agent such as described with respect to FIG. 14, FIG. 15, or FIG. 36, respectively, to receive innovation submission links in search results. A user may also find a shared innovation submission by employing the display 570 of FIG. 37 as described herein or another display that includes a clickable link or links to an innovation submission. In one embodiment, a user may click an “all shared innovations” option in a display to view all shared innovations the user is eligible to view. In any of these displays, a user may click or otherwise highlight an innovation submission description to receive a display of an overview of the innovation submission, such as the Innovation Submission Overview page 900 of FIG. 21 or another display that shows some or all and/or other information than the Innovation Submission Overview page 900

The display of an overview of the innovation submission may include a “comments” button or other link a user may click to receive another display, such as the display 600 of the FIG. 38 embodiment. In one embodiment, a user clicks a “new comment” button (not shown) on the display 600 to add a new comment, or clicks or otherwise highlights one of the existing comments 602 and then clicks the Reply button 604 to reply to an existing comment. In one embodiment, the innovation management system may only allow a user to reply to a comment that is not an analysis or review comment, which may not be shared.

When either the “new comment” button or Reply button 604 is clicked by a user, the user may receive a comment display (not shown) in which the user may input his or her comment, which may include a comment subject or title entry. After the user has input the comment, the user may click an “ok” or other button (not shown) to save the comment. In one embodiment, the user may designate the comment as “private” between the user and the submitter of the innovation submission, such as by clicking a “private” checkbox (not shown) before saving the comment.

Showcase

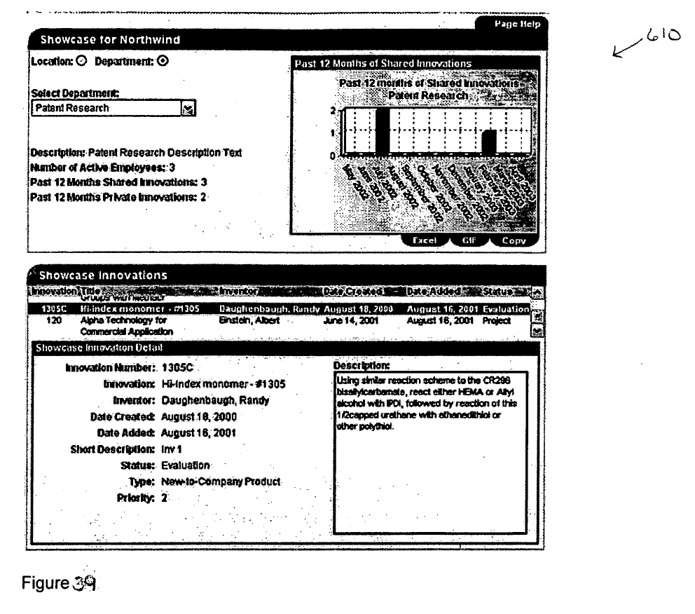

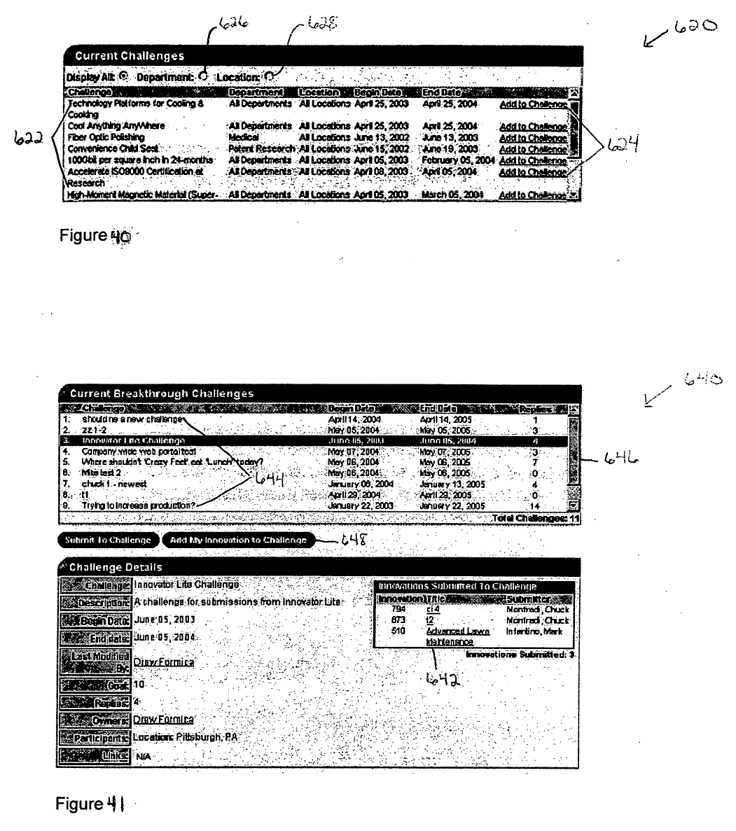

The innovation management system may provide a display, such as the display 610 of FIG. 39, where users, such as those of different departments and/or locations, may “showcase” certain innovation. In one embodiment, showcased innovation submissions may be viewed by one or more users as promising, interesting, or important innovations submissions for the organization to which the users belong. The showcase display may provide a quick demographic overview of the department/location or other group of users and may provide insight into what innovations the organization may feel to be the important to show “outsiders.”

The innovation management system may provide access to the display 610 via a displayed link, such as the “showcase” link of the navigation menu 102 of FIG. 4, which a user may click to receive the display 610. In another embodiment, the user may click the displayed link to receive another display (not shown) from which the user may click one or more links to designate a department, location, and/or other designation of users for which the user wishes to view the display 610.

My Profile Overview

The innovation management system may provide the functionality a user may employ to input a user profile, which may be displayed, in one embodiment, in the display 650 of FIG. 42. The user profile, which may be called “My Profile,” may include biographical data, such as expertise and interests, that the user may customize. Information included in the user profile may be accessible to any user of the innovation management system, and may be found through one of the searches of the innovation management system, such as a search activated by employing the search display 190 of FIG. 14, the display 400 of FIG. 15, or the display 540 of FIG. 36. A user who desires to have his user profile found more often by other users may provide more detailed information in the user profile.

Edit Profile

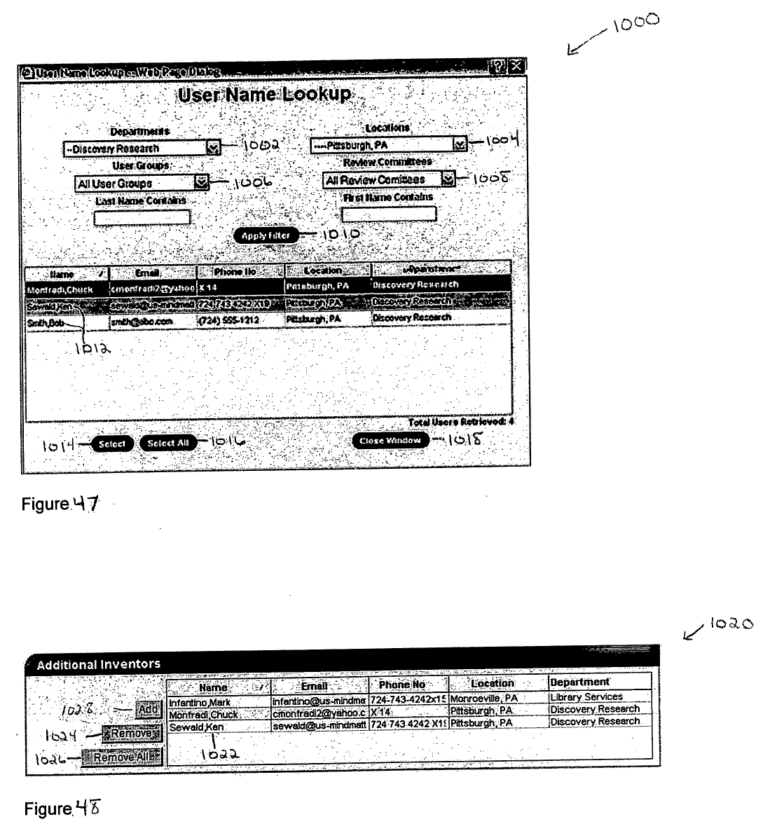

In one embodiment, the innovation management system provides a page, which may include the display 770 of FIG. 46, that a user may employ to edit his or her user profile, which may include user biographical information such as interests, expertise, and/or other information. The user may receive this page, in one embodiment, by clicking the Edit button of the navigation menu 102 of FIG. 4. This page may include areas where a user may enter information about himself or herself.

In an embodiment in which this page includes the display 770 of FIG. 46, a user may click on one of the checkboxes 772 associated with the types of user profile information that may be viewable by others. Those types of user profile information may include one or more of the user's job title, contact information such as email address, phone number, location and department of employment within an organization, information regarding innovation submissions, picture such as a photograph image, expertise, research, publications, links and/or files associated with or of interest to the user, manager or administrator information if applicable, and interests. Clicking on a checkbox 772 may prompt the innovation management system to display text areas and/or Windows Explorer or other file locator displays (not shown) in which the user may enter the types of user information and/or select the files associated with the checkbox, and possibly a “save” or “open” button (not shown) the user may click to save the entered or selected information or file. For example, to enter information concerning interests, the user may click on the checkbox 772 marked “Show Interests,” which may result in a displayed text area in which the user may input information regarding his or her interests, or edit interest information inputted earlier, and a “save” button the user may click to save the entered information. In one embodiment, interest information input earlier may be information an administrator or other user input when he or she created an account for the user by employing a display (not shown), such as a “create new login” screen, that the innovation management system provides. After all user profile information, files, and/or other matter has been entered, the user may click a “save” button (not shown) to save all the matter. In one embodiment, the innovation management system will not save the information unless the user has provided input into each text area provided in association with a clicked on checkbox.

After all user profile matter has been saved by a user, the innovation management system may create and display the edited user profile display for the user. In one embodiment, where a user's location, e-mail, department and/or other descriptive information is different or has recently changed, such as where a user moves to a work department, the innovation management system may be updated, such as by the user or an administrator. The innovation management system may then automatically reflect this updated information with respect to that user throughout the innovation management system.

In an embodiment where the user profile information associated with a checkbox 772 of FIG. 46 includes a selection corresponding to links and files associated with or of interest to the user, such as a “show links and files” selection, a user may click that checkbox 772 to add public or other links to the user's or another's computer files, computer directories, and/or web sites. Clicking that checkbox 772 may result in a display (not shown) that may include an “add” or other button the user may click to receive a drop-down list (not shown). The drop-down list may include a “URL” button the user may click to receive a display (not shown) in which the user may enter the URL address of a website and possibly a description of the website. The drop-down list may include “file” and “file location” buttons, each of which a user may click to receive a display (not shown) that may include a “browse” button. The user may click the “browse” button in one embodiment to open a Microsoft Windows Explorer or other dialog box from which the user may click or otherwise select the file or directory to be shared in the user profile. The display may also include an “open” or other button a user may click to save the file or directory to the innovation management system.

In an embodiment where the user profile information associated with a checkbox 772 of FIG. 46 includes a selection corresponding to pictures, such as a “show picture” selection, a user may click that checkbox 772 to add a photograph image of the user or another image or images. Clicking that checkbox 772 may result in one embodiment in a display (not shown) that may include a “select new picture” or other button the user may click to receive a Microsoft Windows Explorer window or other page, from which the user may click or otherwise select one or more images to be shared in the user profile. The display may also include an “open” or other button a user may click to save the picture or other image or images to the innovation management system. In one embodiment, the display 770 of FIG. 46 includes an indicator, such as the words “No Picture” or a question mark near the selection corresponding to pictures, to indicate that the user has not yet added a picture or other image to the innovation management system.

Logging into the Management System

The innovation management system may provide a display from which a user may logon to the innovation management system, such as by entering a user name, which may be an email address, and password associated with the user account. An innovation management system administrator or other user may set up the account, and the set up may include assigning security privileges that determine which information on the innovation management system the user may access. The administrator may set up the user account such that the user may login in one or more ways. Logging in may prompt the innovation management system to display the user home page or another display from which the user may employ the innovation management system.

One login way may be an automatic network login, such as via NT Authentication, where a user is logged in to his or her company network. For this way, in one example a user may use a computer and follow the following directions: Start MicrosoftT™ Internet Explorer; in the address bar of Explorer, type “innovator” or the appropriate address (e.g., http://www.yourorganization.com) as instructed; if logging in for the first time, follow the requests to download the innovation management system software, including clicking the “Yes” button in the popup window to download the software, and do not cancel the process during download.

If a user is automatically logged in as the wrong user, in an embodiment the user may click a link, such as the “I am not [Name]” link in the user information display 170 of FIG. 12, which may result in a display, such as the display 700 of FIG. 44, in which the user may enter and submit his or her name, email address, and phone number. The innovation management system may automatically forward this information via e-mail to an Administrator for correction.

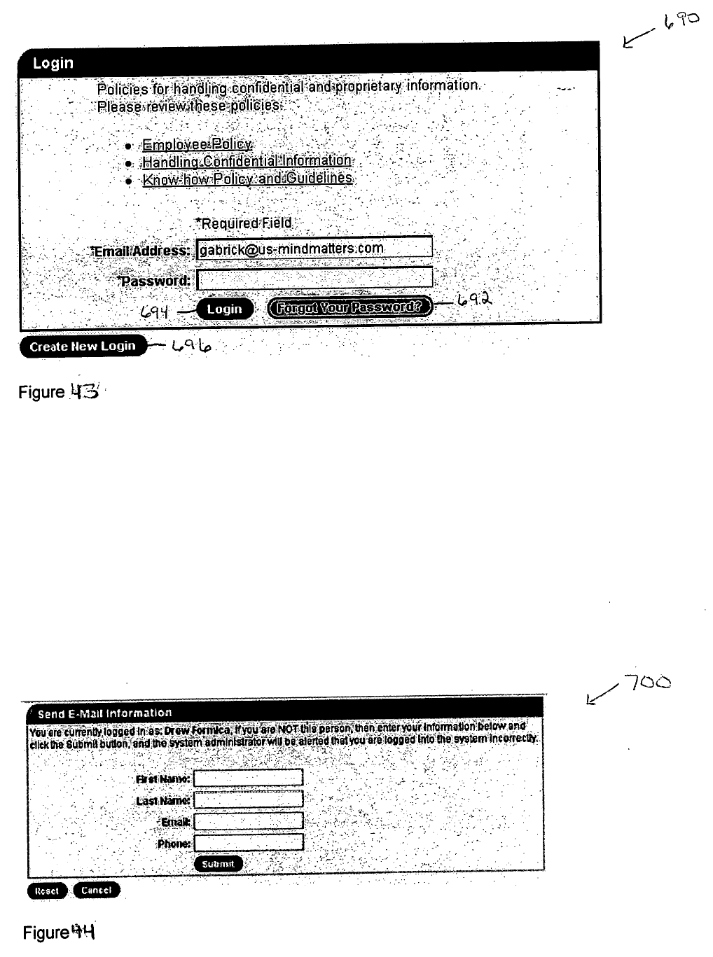

Another login way may require entry of the user name and password of the user in a display, such as the display 690 of FIG. 43. For example, a user may login this way by using a computer and following the following directions: Start Microsoft™ Internet Explorer; in the address bar of Explorer, type “innovator” or the appropriate address (e.g., http://www.yourorganization.com) as instructed; if logging in for the first time, follow the requests to download the innovation management system software, including clicking the “Yes” button in the popup window to download the software, and do not cancel the process during download; in the display 690, type in the user name and password in the appropriate areas; if the password is forgotten your password, click the “Forgot Your Password?” link 692 to be prompted for a previously defined hint-if the hint does not help, seek technical assistance from your innovation management system administrator; click the Login button 694.

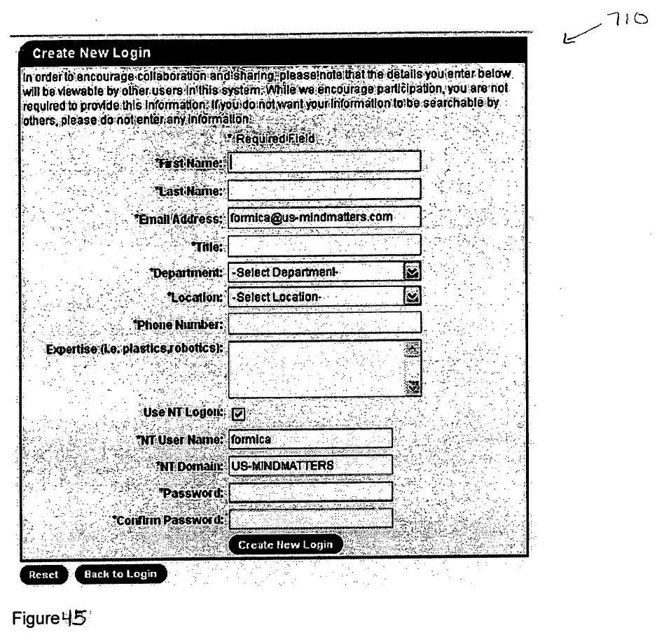

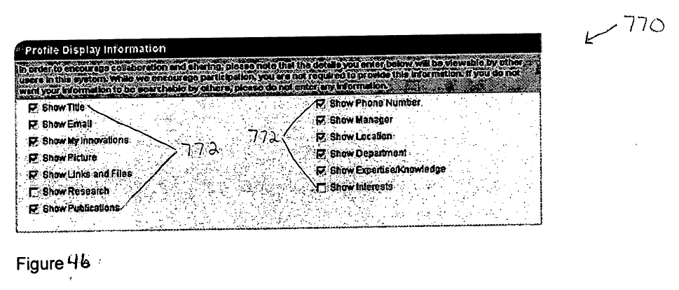

In an embodiment, a user may click the Create New Login button 696 if he or she cannot remember, or does not have, a user name and password. Clicking the button 696 may result in the display 710 of FIG. 45 in which the user may provide information about himself or herself. This information may be included in the user profile, as described herein, of the user. In an embodiment, a user may change his or her password, such as by following the following directions: Access the innovation management system from an Internet browser; at the prompt, enter and submit the user name and password you were given by your trainer/administrator; once logged in, click the “My Profile” button, such as shown on the menu 102 of FIG. 4, then click the “Edit” button; in the new page, clear the existing asterisks in the “password” text box, and type in a new password; clear the existing asterisks in the “confirm password” text box, and retype the password again, and the click the “save” button located on either the top or bottom of this page.

While the management systems, apparatuses, and methods have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

What is claimed is:

1. An innovation management system, comprising:
an input device to receive a description of an innovation from a user;
a storage device to store the description of the innovation; and
a processor to associate at least one piece of information with the stored description of the innovation.

2. The innovation management system of claim 1, wherein the description of the innovation includes text.

3. The innovation management system of claim 1, wherein the description of the innovation includes a drawing.

4. The innovation management system of claim 1, wherein the description of the innovation includes a voice recording

5. The innovation management system of claim 1, wherein the at least one piece of information associated with the description of the innovation includes an additional disclosure from a second user.

6. The innovation management system of claim 1, wherein the at least one piece of information associated with the description of the innovation includes a designation indicating whether the description of the innovation is to be shared with other users.

7. The innovation management system of claim 6, further comprising associating with the description of the innovation an award for the second user for submission of the additional disclosure.

8. The innovation management system of claim 1, wherein the at least one piece of information associated with the description of the innovation includes a description of an additional related innovation.

9. The innovation management system of claim 1, wherein at least one piece of information associated with the description of the innovation includes a status.

10. The innovation management system of claim 1, wherein at least one piece of information associated with the description of the innovation includes an intellectual property status.

11. The innovation management system of claim 1, wherein at least one piece of information associated with the description of the innovation includes a record of user access to the description of the innovation.

12. The innovation management system of claim 1, wherein at least one piece of information associated with the description of the innovation includes a record of an additional submission made by the user related to the description of the innovation.

13. The innovation management system of claim 1, wherein the at least one piece of information associated with the description of the innovation includes a system event including at least one of a notice sent in connection with the description of the innovation and a change of status.

14. The innovation management system of claim 1, wherein the at least one piece of information associated with the description of the innovation includes information to associate non-electronic information with the innovation description.

15. The innovation management system of claim 14, wherein the information to associate non-electronic information with the innovation description includes a barcode.

16. The innovation management system of claim 14, wherein the information to associate non-electronic information with the innovation description includes at least one of a description of the non-electronic information and a location of the non-electronic information.

17. The innovation management system of claim 1, wherein the at least one piece of information associated with the description of the innovation associates non-electronic information with the description of the innovation.

18. The innovation management system of claim 1, wherein the at least one piece of information associated with the description of the innovation includes a date stamp indicating the date the description of the innovation was received by the innovation management system.

19. The innovation management system of claim 18, further comprising a time stamp indicating the time the description of the innovation was received.

20. The innovation management system of claim 1, wherein the at least one piece of information associated with the description of the innovation description includes a task to be performed in connection with the innovation.

21. The innovation management system of claim 20, wherein the task includes a due date.

22. The innovation management system of claim 20, wherein the task includes a status of the task.

23. The innovation management system of claim 20, wherein the task includes a description of the task.

24. The innovation management system of claim 1, wherein the at least one piece of information associated with the description of the innovation includes a user notice.

25. The innovation management system of claim 1, wherein the at least one piece of information associated with the description of the innovation includes a list of users to whom the innovation has been forwarded for comment.

26. The innovation management system of claim 1, wherein the at least one piece of information associated with the description of the innovation includes a list of users to whom the innovation has been forwarded for analysis.

27. The innovation management system of claim 1, wherein the at least one piece of information associated with the description of the innovation includes a security level.

28. The innovation management system of claim 27, wherein the security level indicates that the innovation is to be retained as a trade secret.

29. The innovation management system of claim 27, wherein the security level displays a warning when the innovation is accessed by a user.

30. The innovation management system of claim 27, wherein the security level indicates that the innovation is to be submitted in a patent application.

31. The innovation management system of claim 27, wherein the security level indicates that the innovation is to be submitted in a copyright application.

32. The innovation management system of claim 27, wherein the security level indicates that the innovation is to be submitted in a trademark application.

33. The innovation management system of claim 27, wherein the security level restricts access by a second user to the description of the innovation.

34. The innovation management system of claim 27, wherein the security level prohibits access by a second user not having sufficient security access privileges.

35. The innovation management system of claim 1, wherein at least one piece of information associated with the description of the innovation includes a priority level.

36. The innovation management system of claim 35, wherein the priority level includes a numeric score.

37. The innovation management system of claim 1, wherein the at least one piece of information associated with the description of the innovation includes an incentive.

38. The innovation management system of claim 37, wherein the incentive varies among innovations.

39. The innovation management system of claim 37, wherein the incentive varies based on the submitting user.

40. The innovation management system of claim 37, wherein the incentive varies based upon a technology to which the innovation is related.

41. The innovation management system of claim 37, wherein the incentive varies based upon a department with which the user submitting the innovation is associated.

42. The innovation management system of claim 37, wherein the incentive varies randomly.

43. The innovation management system of claim 37, wherein the incentive varies by date of submission of the innovation.

44. The innovation management system of claim 37, wherein the incentive varies based on a total point budget.

45. The innovation management system of claim 37, wherein the incentive includes a financial reward.

46. The innovation management system of claim 37, wherein the incentive includes a commendation.

47. The innovation management system of claim 37, wherein the incentive includes a career enhancement.

48. The innovation management system of claim 37, wherein the incentive includes a prize.

49. The innovation management system of claim 37, wherein the incentive includes time off work.

50. The innovation management system of claim 1, wherein the at least one piece of information associated with the description of the innovation includes a category in which the innovation falls.

51. The innovation management system of claim 50, wherein the categories are technology areas.

52. The innovation management system of claim 50, wherein the categories are based on differing functions.

53. The innovation management system of claim 1, wherein the processor associates each of a plurality of innovations submitted with one of a plurality of categories.

54. The innovation management system of claim 1, wherein the processor further includes an innovation search agent to periodically search the storage device for innovation descriptions falling in a category selected by a user and display at least a portion of those innovation descriptions to the user.

55. The innovation management system of claim 1, wherein the processor further includes a user search agent to identify users having a desired expertise.

56. The innovation management system of claim 1, wherein the innovation management system displays a template having fields in which information to be associated with the innovation is to be entered.

57. The innovation management system of claim 56, wherein the innovation management system will not accept a description of an innovation unless information is provided in at least one required field.

58. The innovation management system of claim 56, wherein the processor further provides an importance score associated with an innovation based on an entry provided in at least one of the fields.

59. The innovation management system of claim 56, wherein the processor further provides a security score associated with an innovation based on an entry provided in at least one of the fields.

60. The innovation management system of claim 1 wherein:
the at least one piece of information includes at least one keyword associated with the innovation; and
wherein the innovation management system includes a search facility that indicates the innovation description when the at least one keyword is searched.

61. An innovation management system, comprising:
a data storage device having stored thereon a plurality of innovation submissions, at least some of the innovations being associated with at least one of a plurality of categories; and
a processor to retrieve innovations associated with a desired category.

62. The innovation management system of claim 61, wherein the categories include at least one of the department from which innovation was submitted, the location from which innovation was submitted, and the expertise of the person who submitted the innovation.

63. An innovation management system, comprising:
a display device to display an innovation submission;
an input device to input a response to the innovation submission; and
a processor to associate the response with the innovation submission in a storage device.

64. An innovation management network, comprising:
an innovation origination node to receive an innovation submission;
an innovation response node to display the innovation submission and receive an additional submission related to the innovation submission;
a processor to associate the additional submission with the innovation submission.

65. The innovation management system of claim 64, further comprising a storage device to store the innovation submission and the additional submission in association with one another.

66. An innovation stimulation system, comprising:
a transmitting node to receive a description of a problem from a user to be solved;
a storage device to store the description of the problem to be solved;
a receiving node to display the problem to a plurality of second users; and
a processor to associate at least one piece of information received from the plurality of second users related to the problem with the stored description of the problem to be solved.

67. An innovation management system, comprising:
an input device to receive a description of an innovation from a user;
a storage device to store the description of the innovation; and
a processor to evaluate the described innovation.

68. The innovation management system of claim 67, wherein the evaluation includes an analysis based on at least one of the user, a department of which the user is part, a location of the user office, a security associated with the described innovation, and a status of the described innovation.
